(19) United States
(12) Patent Application Publication
(10) Pub. No.: US 2008/0217363 A1
(43) Pub. Date: Sep. 11, 2008

(54) BEVERAGE DISPENSING ASSEMBLY

(76) Inventors: Marc L. Vitantonio, South Russell, OH (US); William E. Rabbitt, Solon, OH (US); John W. Nottingham, Bratenahl, OH (US); John R. Nottingham, Bratenahl, OH (US); John W. Spirk, Gates Mills, OH (US); Jay Tapper, Palm Beach Gardens, FL (US); John Replogle, Raleigh, NC (US); Jeffrey M. Kalman, Cleveland Heights, OH (US)

Correspondence Address: FAY SHARPE LLP, 1100 SUPERIOR AVENUE, SEVENTH FLOOR, CLEVELAND, OH, 44114, US

(21) Appl. No.: 12/040,062

(22) Filed: Feb. 29, 2008

Related U.S. Application Data
(63) Continuation-in-part of application No. 12/014,875, filed on Jan. 16, 2008.
Application No. 12/014,875 is a continuation-in-part of application No. 11/684,326, filed on Mar. 9, 2007.

(51) Int. Cl. B65D 83/00; B67D 5/60

(52) U.S. Cl. 222/399; 222/464.1

(57) ABSTRACT

A beverage dispensing assembly that is capable of dispensing controlled or metered portions of a beverage charged with a gas fits onto a shelf in a conventional household refrigerator. The beverage dispensing assembly includes a sealed disposable container assembly that contains the beverage and a dispensing assembly that cooperates with the container assembly to selectively unseal the container assembly and dispense controlled portions of the beverage from the container assembly.

This application is a continuation-in-part of U.S. patent application Ser. No. 12/014,875, filed Jan. 16, 2008 which is a continuation-in-part of U.S. patent application Ser. No. 11/684,326, filed Mar. 9, 2007 both of which are incorporated herein by reference.

### BACKGROUND

Draft, or draught, beer and carbonated fountain drinks are typically delivered under pressure and include gas, typically nitrogen or carbon dioxide depending on the type of beverage, dissolved in the beverage. These beverages are typically enjoyed at restaurants, bars and other establishments where it makes sense to invest in the devices, e.g. taps, refrigerators, lines, pressure sources and fountain dispensers, that are required to dispense the beverage. To enjoy these beverages at home, typically a consumer must purchase a small portion of the beverage packaged in a can or a bottle. Often times this smaller portion found in a can or bottle is not as enjoyable as its draft or fountain counterpart.

Attempts have been made to provide a beverage dispenser capable of delivering portions of draft beer or a carbonated fountain drink, e.g., soda, where the dispenser is suitable for home usage. Previous approaches include a pressurized gas source, e.g., cartridge, within the liquid containing vessel, typically a bottle or can. In these known devices the gas pressure regulator, which regulates the pressure of the gas that is delivered to the beverage, is found within the liquid containing vessel. This arrangement of components results in the disposal of the costly gas pressure regulator after the beverage in the vessel has been consumed.

Other previous approaches have required the consumer to purchase or incorporate a separate tap and pressurizing system for delivering the beverage. Other approaches, for delivering beer particularly, also include providing a relatively large can, in relation to a typical 12 ounce can which is found in the United States, but these large cans of beer must be consumed relatively quickly, i.e. in at least two days, or the beer would become flat and no longer fresh.

### SUMMARY

In view of the above, disclosed is a beverage dispenser that can deliver desired portions of a pressurized beverage from a vessel containing multiple portions and allow the beverage to stay fresh for a longer period of time as compared to many known beverage containers and dispensers. In one embodiment, a beverage dispensing assembly that is capable of dispensing a beverage charged with a gas fits onto a shelf in a conventional household refrigerator. The beverage dispensing assembly comprises a sealed disposable container assembly that contains the beverage and a dispensing assembly that cooperates with the container assembly to unseal the container assembly and dispense portions of the beverage from the container assembly. The container assembly connects to the dispensing assembly in a manner to allow for disconnection of the container assembly from the dispensing assembly when the beverage has been dispensed from the container assembly and replacement of an empty or nearly empty container assembly with a new sealed container assembly.

A system for dispensing metered portions of a beverage charged with a gas includes a bottle assembly and a dispensing assembly. The bottle assembly includes a bottle and a cap assembly. The bottle includes a neck defining an outlet. The cap assembly includes a pressurized gas cartridge, a beverage valve and a gas valve. The cap is configured to attach onto the neck of the bottle to close the bottle. The pressurized gas cartridge is received in the cap. The beverage valve in the cap allows a desired portion of beverage to leave the bottle and the gas valve allows pressurized gas to enter the bottle. The dispensing assembly is configured to cooperate with the bottle assembly to dispense the beverage from the bottle. The dispensing assembly includes a housing, a spout, and a pressure regulator. The housing supports the bottle, the spout and the pressure regulator. The spout is in fluid communication with the beverage valve for dispensing fluid from the bottle. The pressure regulator is in fluid communication with the pressurized gas cartridge and the gas valve. The pressure regulator receives pressurized gas from the pressurized gas cartridge at a first pressure and delivers pressurized gas to the bottle through the gas valve at a second pressure.

A dispensing assembly for delivering a metered amount of beverage from an associated container that holds the beverage includes a housing, a spout, and a pressure regulator. The housing is configured to receive an associated sealed container storing a beverage. The housing is dimensioned so that the housing and the associated container that the housing is configured to receive fit into an associated conventional household refrigerator and onto a conventional refrigerator shelf. The spout connects to the housing. The spout includes an inlet for receiving beverage from the associated container and an outlet for dispensing beverage. The pressure regulator connects to the housing. The pressure regulator is configured to communicate with an associated pressurized gas cartridge and the associated container to receive pressurized gas from the associated gas cartridge at a first pressure and to deliver pressurized gas to the associated container at a second pressure that is lower than the first pressure.

A disposable container assembly for dispensing a portioned amount of fluid beverage includes a container and a cap. The container stores a beverage. The cap connects to the container for sealing the beverage in the container. The cap includes a cartridge receptacle disposed in the container when the cap is connected to the container.

A disposable container assembly for use with a dispensing assembly that dispenses beverage under pressure includes a sealed disposable bottle, a sealed pressurized gas cartridge, a first plug and a second plug. The sealed disposable bottle includes a gas inlet and a beverage outlet. The sealed pressurized gas cartridge is received in the bottle and arranged to be pierced by an associated dispensing assembly when the bottle is loaded into the associated dispensing assembly. The first plug blocks a passage in communication with the beverage outlet. The first plug precludes the egress of beverage from the bottle when in a closed position and allows the egress of beverage from the bottle when in an open position. The second plug blocks a passage in communication with the beverage outlet. The second plug precludes the egress of beverage from the bottle when in a closed position and allows the ingress of gas into the bottle when in the open position.

A disposable draft beverage refill bottle assembly for use with a dispenser includes a bottle, a cap, a first member, and a second member. The bottle contains a draft beverage. The cap connects to the bottle and contains the beverage in the bottle. The cap includes first and second passages for providing selective communication between inside the bottle and ambient. The first member is disposed in the first passage and has a first operating position that precludes the draft beverage from leaving the bottle and a second operating position that allows the draft beverage to leave the bottle. The second member is disposed in the second passage and has a first operating position that precludes the draft beverage from leaving the bottle and a second operating position that allows pressurized gas to enter the bottle.

A cap for a bottle containing a draft beverage includes a side wall, an end wall, a passage and a cartridge receptacle. The side wall has an inner surface that is generally axially symmetric with respect to a symmetrical axis. The end wall is disposed at or adjacent an end of the side wall. The passage is formed through the end wall generally aligned with the symmetrical axis. The cartridge receptacle is at least partially surrounded by the side wall.

A container assembly for holding a pressurized beverage to be dispensed using an associated dispenser includes a sealed container, a sealed gas cartridge, and a sealed passage. The sealed container stores the beverage under pressure. The sealed gas cartridge is disposed in the container. The sealed passage is arranged to be unsealed when the container is loaded into the associated dispenser and to be unsealed when the associated dispenser is in a dispense operating position.

A cap assembly for a bottle containing a beverage under pressure includes a cap, a gas cartridge, a first normally closed valve and a second normally closed valve. The cap includes a first passage and a second passage. The gas cartridge is received in the cap. The first normally closed valve is disposed in the first passage. The second normally closed valve is disposed in the second passage.

A system for dispensing servings of a beverage charged with a gas includes a sealed bottle and a dispenser. The sealed bottle contains a beverage charged with gas and includes a first sealed passage and a second sealed passage each in communication with inside of the bottle. The dispenser cooperates with the bottle to dispense the beverage from the bottle. The dispenser includes a housing, a spout, a pressure regulator, a first spike and a second spike. The housing receives the bottle. The spout is in fluid communication with the first passage for dispensing the beverage from the bottle. The pressure regulator is in fluid communication with the second passage for delivering pressurized gas to inside the bottle. The first spike unseals the first passage and the second spike unseals the second passage.

### BRIEF DESCRIPTION OF THE DRAWINGS

FIG. 1 is a perspective view of a beverage dispensing assembly.

FIG. 2 is a perspective view of a bottle assembly of the beverage dispensing assembly shown in FIG. 1.

FIG. 3 is an exploded view of the bottle assembly shown in FIG. 2.

FIG. 4 is an exploded view of a dispensing assembly of the beverage dispensing assembly shown in FIG. 1.

FIG. 5 is a perspective view of a locking lever, an alignment bracket and a bottle retainer assembled together and removed from a frame of the dispensing assembly depicted in FIG. 4.

FIG. 6 is an exploded view of a regulator of the dispensing assembly that is shown in FIG. 4.

FIGS. 7-15 depict the steps involved in loading the bottle assembly into the dispensing assembly, dispensing beverage and removing the empty bottle assembly.

FIG. 7 is a cross-sectional view of the bottle assembly prior to insertion into the dispensing assembly.

FIG. 8 is a cross-sectional view of the bottle assembly connected to the dispensing assembly with a locking lever in an unlocked position.

FIG. 9 is a cross-sectional view of the beverage dispensing assembly with the handle in a locked position.

FIG. 10 is a cross-sectional view similar to FIG. 9, but showing different components of the beverage dispensing assembly in cross section.

FIG. 11 is a cross-sectional view similar to that shown in FIGS. 9 and 10 showing a spout of the beverage dispensing assembly in a locked position.

FIG. 12 is a view similar to FIG. 11, however, the spout is rotated into an open position.

FIG. 13 is a cross-sectional view similar to FIGS. 11 and 12, but a tap handle is rotated to a dispense position.

FIG. 14 is a cross-sectional view similar to FIG. 13, but taken to show different components of the beverage dispensing assembly in cross-section.

FIG. 15 is a cross-sectional view depicting the bottle assembly being removed from the dispensing assembly.

FIG. 16 is a perspective view of an alternative embodiment of a beverage dispensing assembly.

FIG. 17 is an exploded view of the assembly shown in FIG. 16.

FIG. 18 is a perspective view of an alternative embodiment of a beverage dispensing system.

FIG. 19 is an exploded view of the beverage dispensing system shown in FIG. 18.

FIG. 20 is a cross-sectional view of the beverage dispensing assembly shown in FIG. 18 taken along a longitudinal axis of the assembly.

FIG. 21 is a cross-sectional view taken parallel to the cross-sectional view shown in FIG. 20, but spaced radially therefrom.

FIG. 22 is a perspective view of the beverage dispensing assembly depicted in FIG. 18. The bottle assembly and the lower housing are not shown.

FIG. 23 is a perspective view of an alternative embodiment of a beverage dispensing system shown in an open position.

FIG. 24 is a front view of the beverage dispensing assembly shown in FIG. 23.

FIG. 25 is a perspective view of the beverage dispensing system shown in FIG. 23 in a closed position.

FIG. 26 shows a view of the internal components of the beverage dispensing assembly shown in FIG. 23.

FIG. 27 is an alternative view showing the internal components of the beverage dispensing assembly shown in FIG. 23.

FIGS. 28a-28d are schematic depictions of an alternative embodiment of a beverage dispensing system.

FIGS. 29a-29d are schematic depictions of an alternative embodiment of a beverage dispensing system.

FIG. 30 is a cross-sectional view of a beverage dispensing assembly showing a stage in the process of piercing of a gas cartridge.

FIG. 31 is a cross-sectional view of the beverage dispensing assembly showing a later stage in the process of piercing a gas cartridge.

FIG. 32 is a cross-sectional view of a container for use with a beverage dispensing system.

FIG. 33 is a cross-sectional view of a container for use with a beverage dispensing system, FIG. 33 shows the entire container in cross section.

### DETAILED DESCRIPTION

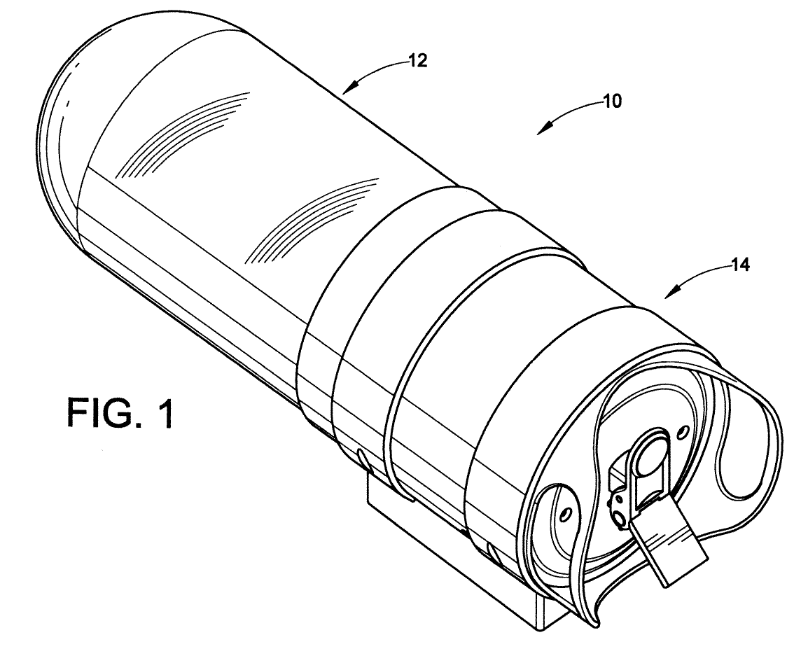

A beverage dispensing assembly 10, per the embodiment depicted in FIG. 1, includes a bottle assembly 12 and a dispensing assembly 14. The dispensing assembly 10 as shown in FIG. 1 is dimensioned and configured so that it fits into a conventional household refrigerator. More particular to the embodiment depicted in FIG. 1, the beverage dispensing assembly 10 is configured to rest in a generally horizontal configuration, e.g., the axis of symmetry for the bottle of the assembly resides generally parallel to a plane of the refrigerator shelf upon which the beverage dispensing assembly 10 will rest. Moreover, the beverage dispensing assembly 10 that is depicted in FIG. 1 has a height that is limited in its greatest dimension so that the beverage dispensing assembly can fit onto a conventional household refrigerator shelf, typically, a middle shelf where an upper shelf resides above the shelf upon which the beverage dispensing assembly 10 resides. The length, or depth, of the assembly is also limited to less than about 40 cm so that the refrigerator door can close and seal. The beverage dispensing assembly 10 can have dimensions that are roughly equal to the dimensions of a 12 pack of beverage cans sold in a cardboard or paperboard box where the cans are stacked 6 by 2, which is more particularly described, for example, in U.S. Pat. No. 6,484,903.

Alternatively, the bottle assembly 12 and the dispensing assembly 14 can be configured in a manner to allow the beverage dispensing assembly 10 to reside in a generally vertical configuration, for example, where the beverage dispensing assembly may be received in a shelf found in a refrigerator door of a conventional household refrigerator. Other possible configurations also exist that are within the scope of the invention.

The beverage dispensing assembly 10 is useful in delivering metered portions of draft beer or fountain soda, both of which will be referred to as a draft beverage, without requiring the consumer to purchase a keg and tap assembly in the case of draft beer or a fountain dispenser and other equipment required to dispense fountain soda. The beverage dispensing assembly 10 provides a disposable, which is meant to include recyclable, bottle assembly where inexpensive components are disposed or recycled and the costlier components, e.g. a pressure regulator, is not thrown away. The assembly delivers a fresh tasting beverage each time over an extended period of time, e.g. at least about 21 days.

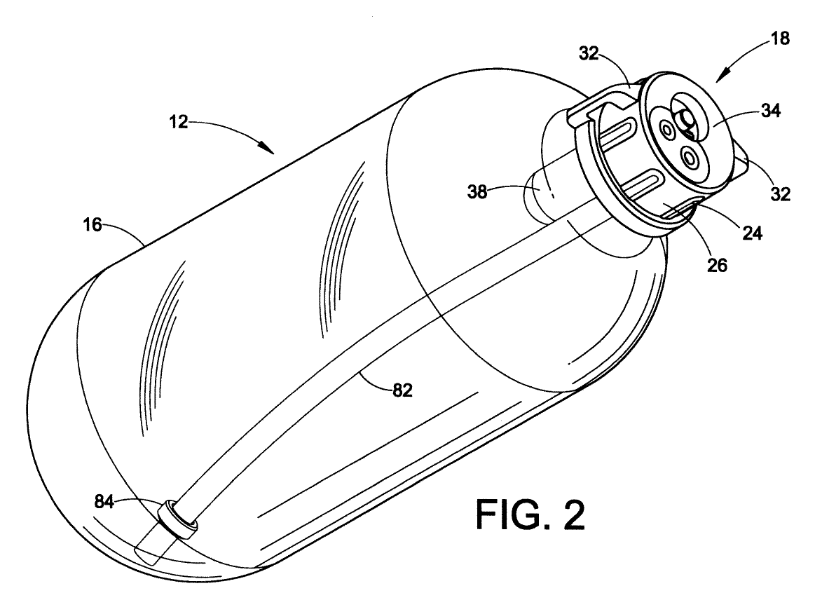

With reference to FIG. 2, the bottle assembly 12 includes a bottle 16 and a cap assembly 18. The bottle assembly 12 fits into the dispensing assembly 14 (FIG. 1) and is manufactured to be disposable or recyclable. A consumer purchases the beverage dispensing assembly 10 and dispenses the beverage. After the beverage is dispensed and consumed, the consumer removes the empty bottle assembly 12 from the dispensing assembly 14 and buys a replacement bottle assembly to fit into the dispensing assembly.

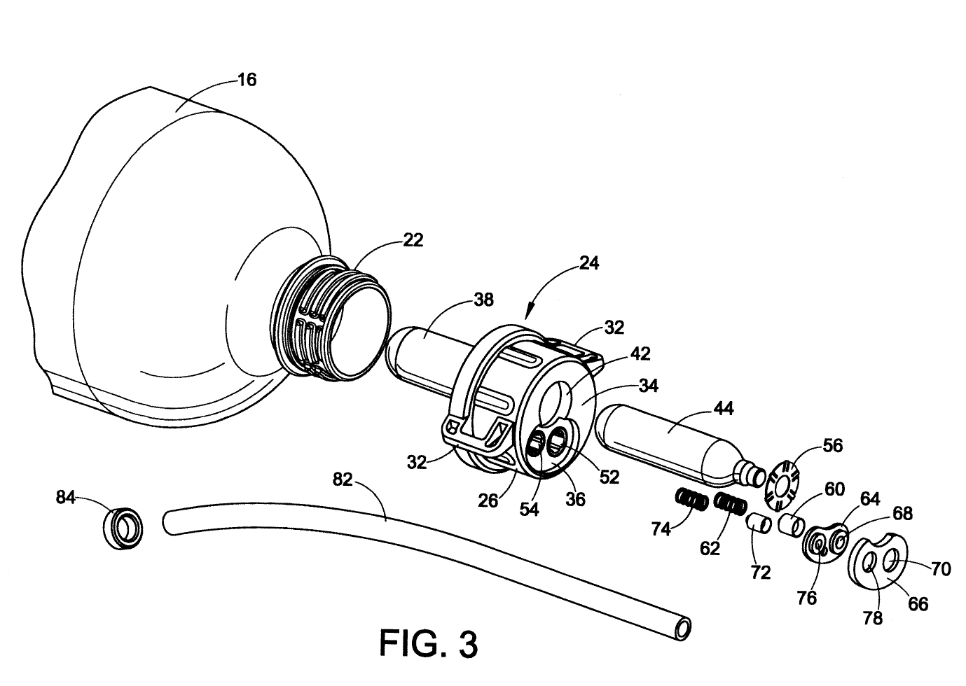

The bottle 16 as shown in the depicted embodiment is a blow molded axially symmetric bottle having an externally threaded neck 22 (FIG. 3). In the depicted embodiment, the bottle can be manufactured to have an internal volume of between about 1 liter and about 5 liters, and even larger if desired. The larger the internal volume allows a manufacturer to spread the cost associated with the cap assembly 18 over a larger amount of beverage, which drives down the unit cost of the beverage. Other materials for the bottle 16 can be used, but plastic is easily recyclable and the threaded neck 22, which could be modified so that it does not include threads, allows for easy removal of the cap assembly 18 when all the beverage has been dispensed. This allows for separation of the cap assembly 18 from the bottle 16 so that the dissimilar materials used in the cap assembly can be separated from the bottle. The diameter of the bottle 16 in the depicted embodiment is between about 7 cm and about 16 cm, which is typically less than the height of a shelf in a conventional household refrigerator. Where the beverage dispensing assembly 10 is configured to be placed into a door of a conventional household refrigerator, the diameter of the bottle 16 can be between about 13 cm and about 18 cm. The assembly 10 has a length measured along a central axis of about 33 cm to about 40 cm, which is less than the depth of the refrigerator compartment of a conventional household refrigerator so that the beverage dispensing assembly can sit on the shelf horizontally. In the depicted embodiment, the bottle 16 is clear and/or translucent to allow the consumer to see the beverage inside the bottle. If desired, the bottle can be opaque, especially where the bottle is made from a material other than plastic.

The cap assembly 18 covers the opening through which the bottle 16 is filled with beverage and retains the beverage in bottle 16 during shipment. In the depicted embodiment, the cap assembly includes openings for dispensing the beverage and providing pressurized gas to the beverage, which will be explained in more detail below. In alternative embodiments, the passages for dispensing the beverage and for providing pressurized gas to the bottle can be formed in the bottle—one non-limiting example being passages formed near and radially offset from the neck 22. With reference back to the embodiment depicted in FIG. 3, the cap assembly 18 generally includes a cap 24, a pressure source, and valve assemblies. These can also be located in the bottle, if desired.

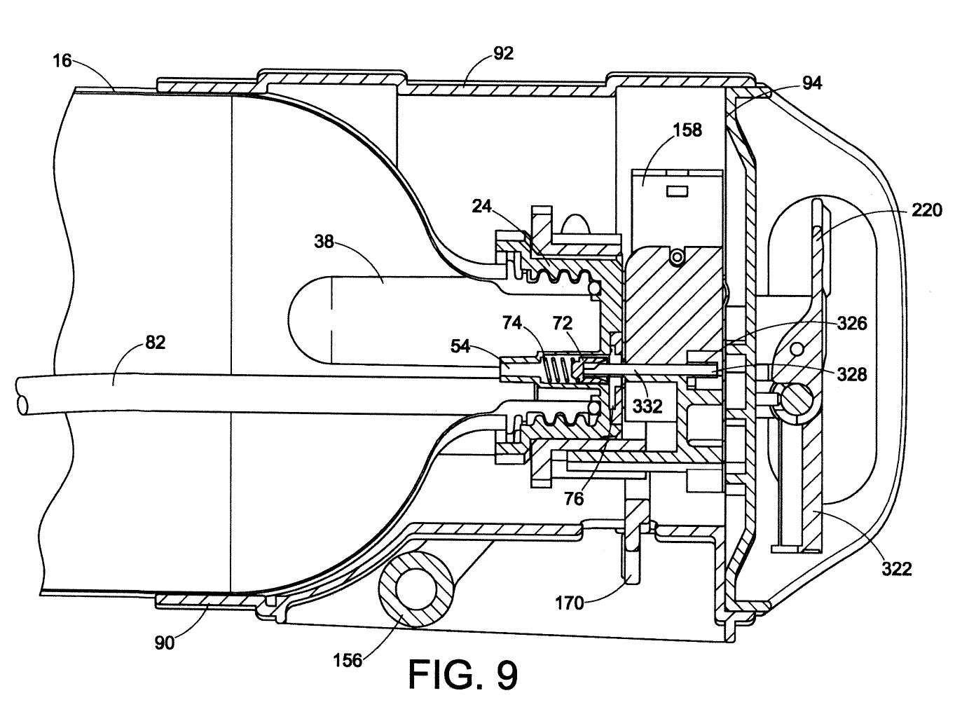

The cap 24 threads on to the threaded neck 22 of the bottle 16. The cap 24 could connect to the bottle in other manners, e.g. a bayonet connection, a snap fit, or welding. With reference back to the embodiment of FIG. 3, the cap 24 includes a generally cylindrical side wall 26 having internal threads 28 (FIG. 8) formed on an inner surface for threadingly engaging the threaded neck 22. The cap 24 also includes two catches 32 that extend outwardly from the cylindrical side wall 26 of the cap 24. The catches 32 are generally U-shaped bars and the terminal portions attach to the cylindrical side wall 26 to define an opening to facilitate attaching the bottle assembly 12 to the dispensing assembly 14 in a manner that will be described in more detail below.

The catches 32 align with a chord that is offset from the diameter of a circular end wall 34 of the cap and intersects the diameter of an opening 42 that leads to a cartridge receptacle 38 (described below). The circular end wall 34 at an upper end of the cylindrical side wall 26, includes a valve seat recess 36 and, in the depicted embodiment, three openings, which will be described in more detail below. The cap 24 also includes a cartridge receptacle 38 that receives the pressure source for the beverage dispensing assembly 10. A cartridge receptacle opening 42, which is one of the three openings in the circular end wall 34, leads to a cavity that is defined by the cartridge receptacle. The cartridge receptacle 42 is offset from a rotational axis of the cap 24, i.e. the axis about which the cap 24 rotates to be screwed onto or removed from the threaded neck 22 of the bottle 16. The cartridge receptacle 38 is configured to receive a conventional 12 ounce CO₂ cartridge 44. In other embodiments, the cartridge receptacle 38 can take other configurations to allow it to receive pressurized gas cartridges, for example, nitrogen cartridges or CO₂ cartridges that have a different volume. The cartridge receptacle 38 is closed with the exception of the opening 42 in the circular end wall 36 so that the internal compartment of the cartridge receptacle is not in communication with the bottle 16 when the cap 24 is connected to the threaded neck 22.

The cap 24 also includes a beverage outlet passage 52 and a pressurized gas inlet passage 54, each of these passages being in communication with a separate opening, mentioned above, formed in the circular end wall 34. Each passage 52 and 54 extends through the cap 24 such that each passage is in communication with the internal volume of the bottle 16. Each passage 52 and 54 is sealed after the beverage manufacturer has filled the bottle 16 to transport the bottle from the manufacturer to the retailer. In one example, foil, or other sealing device such as rubber, plastic and the like, can act as a plug to block the passages 52 and 54 to prevent the egress of beverage from the bottle during shipment. In another example, valve assemblies, which will be described in more detail below, are used to seal the passages 52 and 54.

As mentioned above, the pressure source in the depicted embodiment is a conventional CO₂ cartridge 44 that fits into the cartridge receptacle 38. The type of cartridge used in the depicted embodiment is pierced in a manner that will be described later. A locking clip 56 retains the cartridge 44 in the cartridge receptacle 38. The locking clip 56 in the depicted embodiment includes a central opening that receives the neck portion of the cartridge and a peripheral portion that engages the side wall of the cartridge receptacle. The cartridge 44 can be retained in other manners.

With continued reference to FIG. 3, the beverage outlet valve assembly includes a plug 60 and a biasing member, such as a spring 62, that biases the plug into a closed position. The plug 60 acts against a seal 64 that is retained by a seal retainer 66 that both fit into the valve seat recess 36 formed in the circular end wall 34 of the cap 24. The seal retainer 66 is welded to the cap 24 in the present embodiment. The spring 62 and the valve plug 60 are positioned inside the beverage outlet passage 52 and the spring 62 urges the plug 60 towards the seal 64. The seal 64 includes a first opening 68 that aligns with the beverage outlet passage 52. Similarly, the seal retainer includes a first opening 70 that aligns with the first opening 66 and the seal 64 and the beverage outlet passage 52 in the cap 24. These openings 68 and 70 and the beverage outlet passage 52 are blocked when the plug 60 is moved into the closed position. As most clearly seen in FIG. 8, the beverage outlet passage 52 is stepped to allow the spring 62 to seat in the outlet passage 52 and bias the plug 60 towards the seal 64 thus blocking the beverage outlet passage 52. If desired, the spring can be removed and the plug 60 can be biased by the pressurized beverage in the bottle 16.

In a similar fashion, as seen in FIG. 3 the pressurized gas valve assembly includes a plug 72 that is biased by a spring 74 towards the seal 64. The seal 64 includes a second opening 76 that aligns with the pressurized gas inlet passage 54. The seal retainer 66 also includes a second opening 78 that aligns with both the second opening 76 in the seal 64 and the pressurized gas inlet 54 that is formed in the cap 24. The plug 72 seals against the seal 64 to prevent the beverage and gas from leaving the bottle 16 through the pressurized gas inlet 54 until the plug 72 is moved away from the seal. As seen in FIG. 8, the gas inlet passage 54 is also stepped to provide a seat for the spring 74. If desired, the spring can be removed and the plug 72 can be biased by the internal pressure of the pressurized beverage in the bottle.

A hollow flexible dip tube 82 attaches to the cap 24 and is communication with the beverage outlet passage 52. A dip tube weight 84 attaches at a distal end of the dip tube. The dip tube 82 extends from the cap 24 a length that is slightly greater than the length of the bottle 16 that is found below the threaded neck 22. Accordingly, the dip tube 82, which is made from a flexible material, can have a slight curvature such that the dip tube resides at a lower most location in the bottle to allow for full evacuation of the bottle 16 as beverage is dispensed from the bottle. In the depicted embodiment, the dip tube weight 84 is a ring that receives the dip tube. The dip tube weight can take alternative configurations and attach to the dip tube in alternative manners.

As discussed above, the cap assembly 18 retains the draft beverage in the bottle during shipment and includes components that allow for the dispensing of metered portions of a pressurized and/or carbonated beverage from the bottle 16. Some or many of the components depicted in the cap assembly can be placed in the dispensing assembly, for example the valve assemblies and the CO₂ cartridge. The usefulness of providing the valve assemblies in the cap 24, as opposed to putting these assemblies in the dispensing assembly 14, is if some beverage remains in the bottle 16, the bottle assembly 12 can still be removed from the dispensing assembly 14 because the plugs 60 and 72 are biased towards a closed position that prohibits the beverage and gas from leaving the bottle.

As discussed above, the dispensing assembly 14 receives the bottle assembly 12. The bottle assembly 12 is designed to be removed from the dispenser assembly 14 after the beverage has been dispensed, or earlier if desired, and replaced with a new bottle assembly. The dispenser assembly 14 includes more of the expensive components of the system and is designed to be reused with many different bottle assemblies.

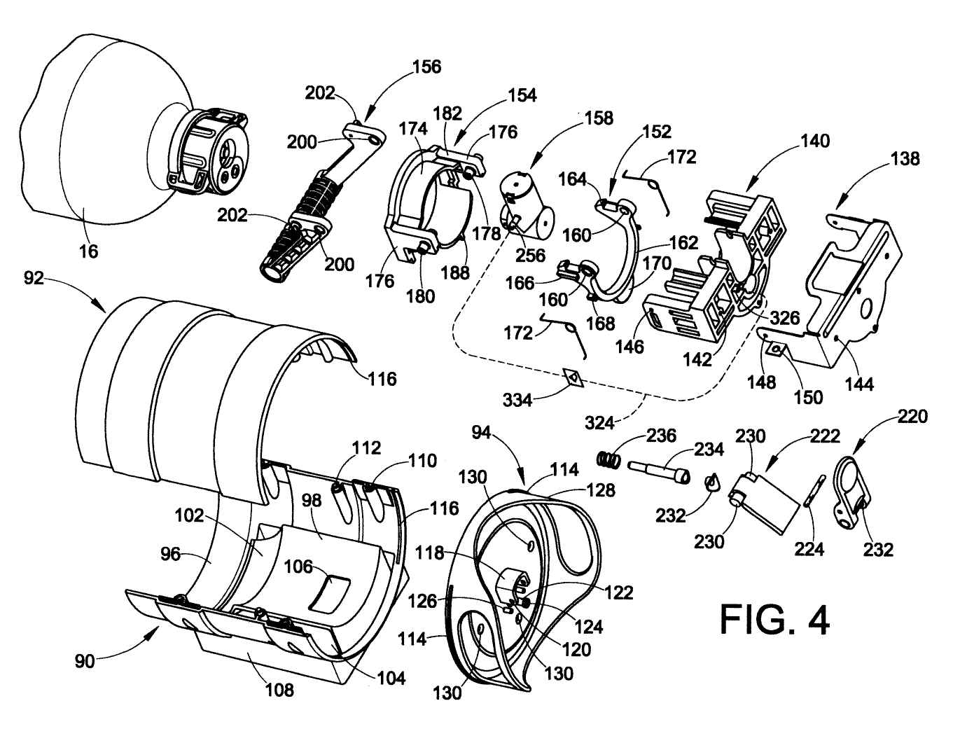

With reference to FIG. 4, the dispensing assembly includes a housing, which in the depicted embodiment includes a base or lower housing 90, a lid or an upper housing 92, and a face plate or front housing 94. The housing portions 90, 92, and 94 attach to one another to form a generally cylindrical housing as seen in FIG. 1. The housing can take other configurations and can be made from a fewer or greater number of components. In the depicted embodiment the housing is made of a plastic material, but other materials can be used.

The lower housing is generally half-cylindrical and includes a curved base surface 96. A forward platform 98 begins at a location is axially spaced from a rear edge of the base housing (with respect to the front face 94) and extends towards the front edge of the base 90 to almost the front face 94 when the housing portions are connected to one another. The forward platform 98 is radially spaced from the base surface 96 and is also curved. A concave ramp 102 connects the inner base surface 96 to the forward platform 98. The ramp 102 has a curvature that is complementary to the curvature of the bottle 16 between its widest diameter portion and the threaded neck 22. As seen FIG. 8, for example, the portion of the bottle where its diameter progressively decreases towards the threaded neck 22 abuts against the ramp 102 when the bottle assembly 12 is fully inserted into the dispensing assembly 14.

The forward platform 98 is also separated from the inner base surface 96 by openings 104 (only one is visible in FIG. 4) on each side of the platform that is generally parallel to a central axis of the housing. The forward platform 98 also includes a central generally rectangular opening 106. Each of the openings 104 and 106 allows for components that allow for the mounting of the bottle assembly 12 into the dispensing assembly 14 to be accessible by the consumer. These components will be described in more detail below.

The base housing 90 also includes an integral base 108 extending downwardly that provides a planar support surface for the beverage dispensing assembly 10. The planar support surface is slightly inclined so that the rearward portion of the bottle 16 is lower than the forward portion of the bottle to allow the beverage to puddle towards the inlet of the dip tube 82 to promote full evacuation. Fastener openings 110 are provided in the base housing 90 for attaching the lid 92 to the base housing. The base housing 90 can attach to the lid in other conventional manners. Also, support posts 112 are formed in the base housing 90, the function of which will be described below.

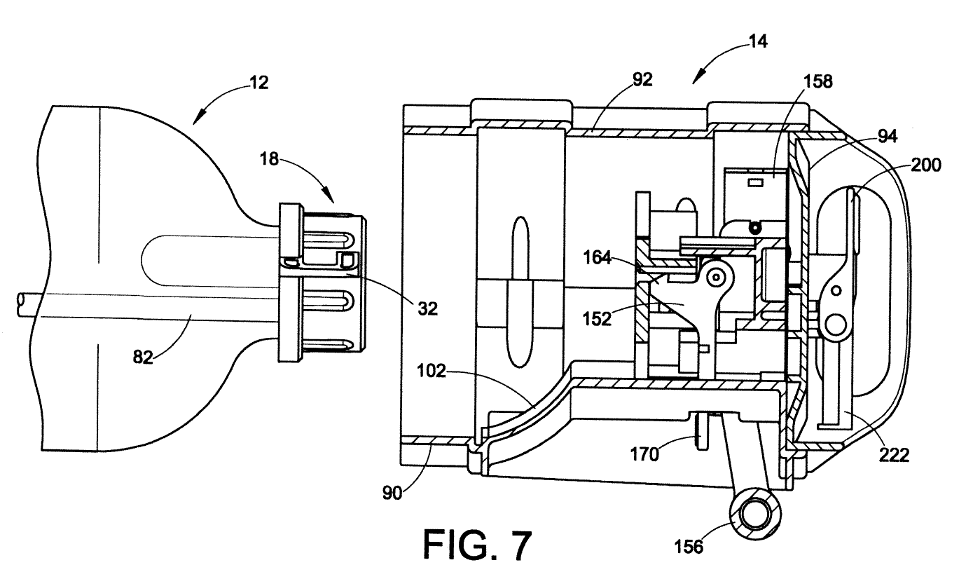

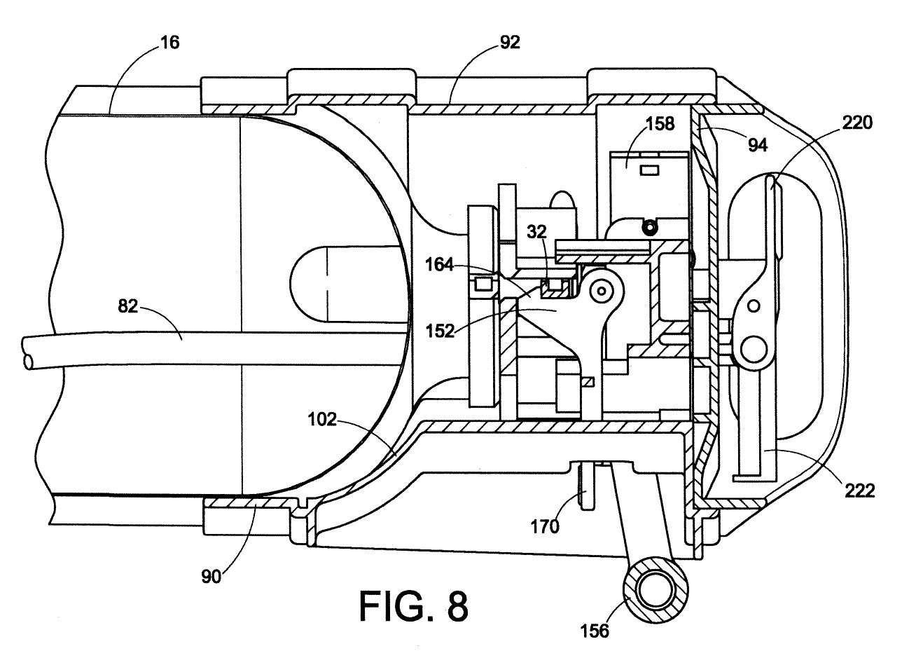

The lid 92 is generally half-cylindrical in shape. It includes a plurality of fastener openings (not visible) that align with the fastener openings 110 in the base housing 90 to attach the lid to the base housing. When the lid 92 is attached to the base housing 90 the diameter of the housing is slightly larger than the maximum diameter of the bottle 16, see for example FIG. 7.

The face plate 94 is sandwiched between the base housing 90 and the lid 92. In the depicted embodiment, the face plate includes ridges 114 that are received in notches 116 formed in the base housing 90 and the lid 92 that fix the face plate in an axial direction. The face plate 94 also includes an external mounting extension 118 that extends outwardly from and is generally centrally located in the face plate. The mounting extension 118 has a generally upside-down U-shaped configuration and includes aligned pin openings 120 on each side of the U-shape. The face plate 94 also includes a generally centrally located boss 122 that defines a passage 124 through which components involved in beverage dispensing extend, which will be described in more detail below. Small posts 126 are positioned on opposite sides of the boss 122 and are generally aligned with one another. The face plate 94 also includes handles 128 extending outwardly from the face plate on opposite sides of the face plate and a plurality of fastener openings 130 that extend through the face plate.

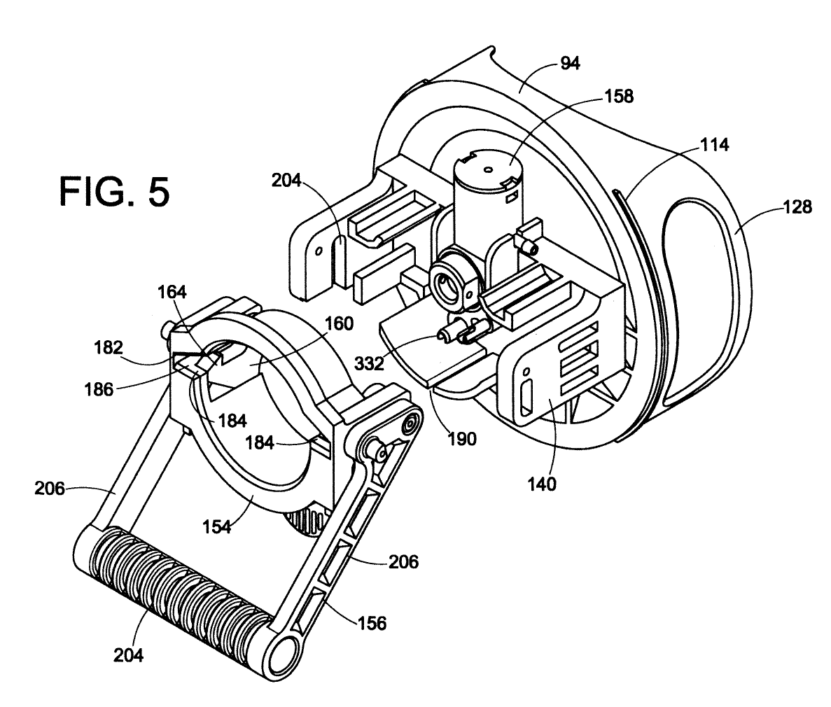

The fastener openings 130 in the face plate 94 allow for the attachment of a frame cover 138 and a frame 140 against an inner surface of the face plate, as seen in FIG. 5. The frame 140 includes a plurality of fastener openings 142 that align with fastener openings 144 in the frame cover 138 and fastener openings 130 the face plate 94 to receive fasteners (not shown) for attaching the frame and frame cover to the face plate. The frame 140 includes additional fastener openings 146 that align with fastener openings 148 in the cover 138 to attach the two together. The frame cover 138 also includes openings 150 that receive support posts 112 to fix the cover and the frame 140 in the housing. The frame 140 provides a support for components of the dispenser assembly 14 that provide the connection between the bottle assembly 12 and the dispenser assembly 14.

A bottle retainer 152, an alignment bracket 154, and a locking lever 156 cooperate with the frame 140 to connect the bottle assembly 12 to the dispensing assembly 14. A pressure regulator 158, which will be described in more detail below, also cooperates with the frame 140, the bottle retainer 150, the alignment bracket 152 and the locking lever 154.

The bottle retainer 152 in the depicted embodiment includes a generally U-shaped member 162 with openings 160 formed at opposite ends. The openings 160 provide a means for attaching the bottle retainer 152 to the alignment bracket 154. Catches 164 extend from each end of the U-shaped member 162 near the openings 160 towards the alignment bracket 154. Ridges 166 extend from the outer side of the bottle retainer between the end of each catch 164 and each opening 160. Also, spring catches 168 are formed underneath each opening on the U-shaped member. A tab 170 extends downwardly from the center of the U-shaped member 162, which is the lower most portion of the bottle retainer 152 as depicted in FIG. 4. Springs 172 bias the bottle retainer in a rotational direction towards the bottle assembly 12.

The alignment bracket 154 in the depicted embodiment includes a circular section 174 and two appendages 176 extending from diametrically opposite sides of circular section 174 towards the bottle retainer 152 when finally assembled. A first pair of inwardly extending axle posts 178 extend towards each other from each distal end of each appendage 176. Each axle post 178 is received in a respective opening 160 of the bottle retainer 152. A second pair of axle posts 180 extend outwardly from each appendage 176 and are generally coaxial with the first axle posts 178.

The circular section 174 of the alignment bracket 154 is configured to receive the circular cap 24 that connects to the bottle 16. Outer ends of an upper portion of the circular section 174 form upper and lower alignment surfaces 182 and 184, respectively, extend inwardly from each appendage 176 and towards the bottle retainer 152 to define a channel 186 (FIG. 5) that receives the catches 32 formed in the cap. The lower alignment surfaces 184 do not extend along the central axis of the circular section 174 as great a distance as compared to the upper alignment surfaces 178 (see FIG. 5), which allows the catches 164 of the bottle retainer 152 to engage the catches 32 on the cap 24, in a manner that will be described in more detail below. The alignment bracket 154 also includes a lower downwardly extending ridge 188 aligned with a central axis of the circular section 170 that is received in linear notch 190 formed in the frame 140. Both the alignment bracket 154 and the bottle retainer 152 are configured to move linearly with respect to the frame 140 in a manner that will be described in more detail below.

The locking lever 156 is also generally U-shaped in configuration and includes openings 200 that receive respective mounting posts 180 of the alignment bracket 154. The locking lever 156 also includes outwardly protruding posts 202 that are received in vertical slots 204 (FIG. 5) formed in the frame 140. The posts 202 include a flattened section so that the posts 202 lock into a locked position or an unlocked position when a hand grip 204, which is disposed between two appendages 206 that include the openings 200 and the mounting posts 202, is moved from an unlocked position toward a locked position, which will be described in more detail below.

With reference to FIG. 4, the dispensing assembly 14 also includes a tap handle 220 and a spout 222 that each attach to the face plate 94 of the housing. The tap handle 220 is rotated with respect to the face plate 94 to dispense a metered portion of a pressurized beverage from the bottle 16 through the spout 222. The tap handle 220 attaches to the mounting extension 118 of the face plate 94 via a pin 224 that is received in openings 226 in the tap handle and in the openings 120 provided in the mounting extension 116 on the face plate 94. The spout 222 is formed to include hubs 230 that are received in receptacles 232 formed in the tap handle 220.

The tap handle 220 and the spout 222 cooperate with a hollow seal 232, a beverage valve actuator 234 and a spring 236 to dispense metered portions of a beverage from the bottle 16 in a manner that will be described in more detail below.

As discussed above, the beverage dispensing assembly 10 is capable of providing pressurized gas to the bottle 16 so that the contents of the bottle stay fresh over an extended period of time. The gas pressure also propels the beverage. The pressure regulator 158 that is shown above cooperates with the pressure source found in the cap assembly 18 to provide pressurized gas to the inside of the bottle. The pressure regulator 158 receives gas at a first pressure from the pressure source and delivers at a second pressure, which is lower than the first pressure, to the bottle 16.

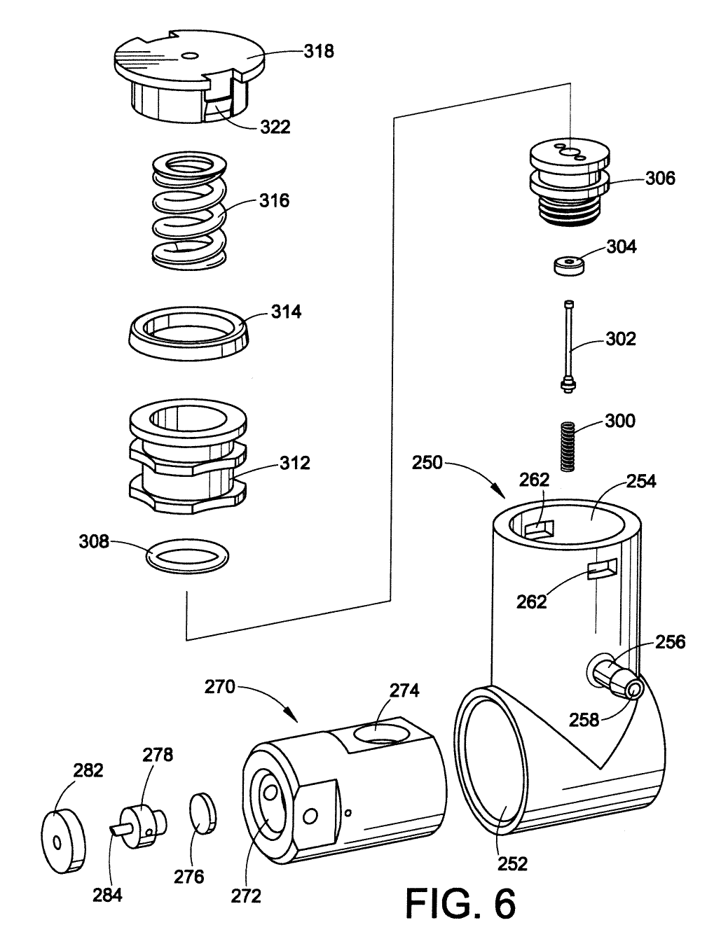

With reference to FIG. 6, the regulator 156 includes a regulator body 250 that includes a first (horizontal) cylindrical opening 252 having a symmetrical axis extending along a first direction and a second (vertical) cylindrical opening 254 that is communication with the first cylindrical opening 252 and includes a symmetrical axis that is perpendicular to the symmetrical axis of the first cylindrical opening. A nipple 256 extends from the regulator body and includes a passage 258 that is in communication with the vertical passage 254 in the regulator body. The regulator body 250 also includes two rectangular openings 262 that are diametrically opposed from one another and disposed adjacent an upper end of the vertical opening 254.

The horizontal cylindrical opening 252 receives a piercing mechanism housing 270. The piercing mechanism housing 270 includes a generally horizontal cylindrical passage 272 that connects with a generally vertical cylindrical passage 274. The vertical passage 274 in the piercing mechanism housing 270 aligns with the vertical passage 254 of the regulator body 250 when the piercing housing mechanism 270 is received in the horizontal passage 252. In the depicted embodiment, internal threads are provided in the vertical passage 274 of the piercing mechanism housing 270.

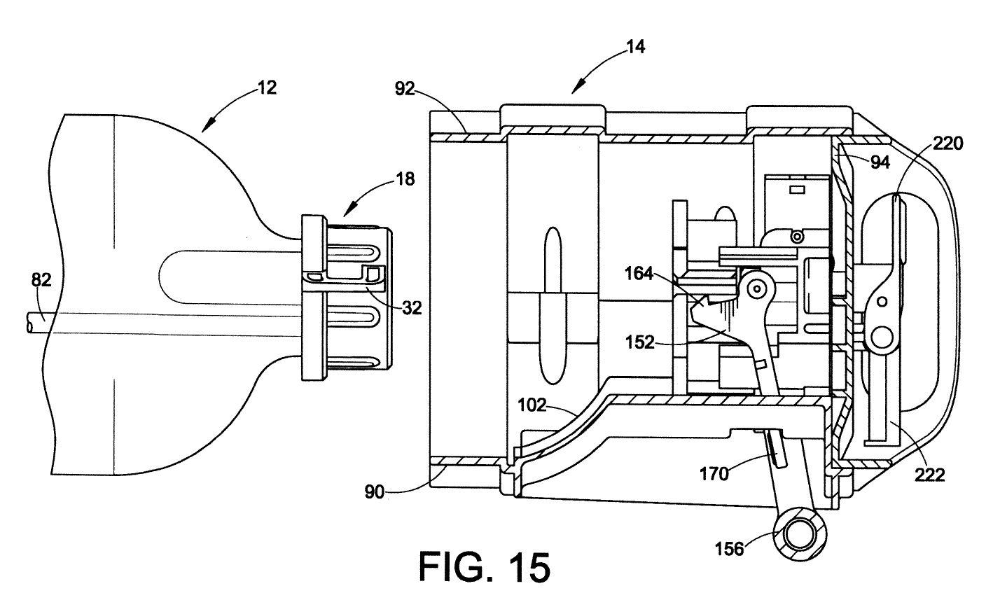

The piercing mechanism housing 270 receives a filter 276, a piercing pin 278, and gasket 282 in the horizontal passage 272. The piercing pin 278 is hollow and includes a passage 284 extend through the piercing pin that communicates with a smaller horizontal passage 286 in the piercing mechanism housing 270 and a smaller vertical passage 288 in the piercing mechanism housing 274 (FIG. 14). The piercing pin 278 also includes a sharp edge that extends outwardly from the piercing mechanism housing 270 so as to pierce the pressurized gas cartridge 44 (FIG. 3) in a manner that will be described in more detail below.

The vertical passage 254 in the regulator body 250 receives a small spring 300, a valve pin 302, a valve seal 304, a plug 306, an O-ring 308, a piston 312, a piston seal 314, a larger spring 316 and a cap 318. With reference to FIG. 14, the spring 300 is received in the smaller vertical passage 288 of the piercing mechanism housing 270. A lower portion of the valve pin 302 is also received in the vertical opening 288. The valve seal 304 includes an opening for receiving the valve pin, as does the plug 306. The plug 306 includes a threaded portion that is threaded into the larger vertical opening 274 of the piercing mechanism housing 270. An O-ring 308 surrounds the plug 306 and contacts a circular side wall of the regulator body 250.

The cap 318 includes a pair of resilient tabs 322 that snap into the rectangular openings 262 of the regulator body 250. The larger spring 316 biases the piston 312 downwardly in the piston seal contacts an outer surface of the piston 312 and an inner surface of the regulator body 250.

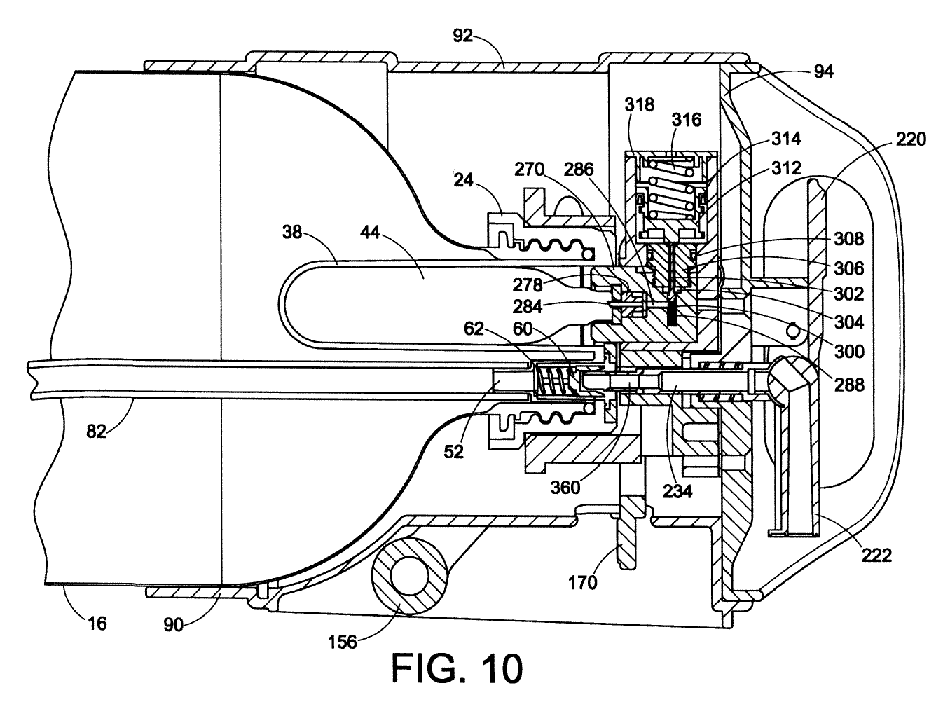

Pressurized gas (under high pressure—about 850 psig) exits the cartridge 44 through the passage 284 and into the smaller horizontal passage 286 of the piercing mechanism housing 270. The spring 300 biases the valve stem 302 against the seal 304 closing the vertical passage through the plug 306. Lower pressure (P_{L}), which is equal to the pressure of the beverage in the bottle 16 (about 16 psig, but can be anywhere between about 5 psig to about 35 psig) is in a chamber defined above the O-ring 308. After some of the beverage has been dispensed (or at the initial charge), the pressure above the O-ring 308 drops below P_{L}. The upper spring 316 then biases the piston 312 which presses down on the valve stem 302 unseating the valve stem from the seal 304. Gas then moves through the passage in the plug 306 and out the nipple 256 until P_{L} is again reached above the O-ring 308, which moves the piston 312 against the spring 316. A hose 324 (depicted schematically in FIG. 4), attaches to a corresponding nipple 326 formed in the frame 140 having an internal passage 328 (FIG. 9) to deliver pressure at or about P_{L} to the bottle. A rearwardly extending hollow cartridge spike 332 extends from the frame 140 and is received in the gas inlet passage 54 to provide pressurized gas to the internal volume of the bottle 16. The rearwardly extending hollow spike 332 also defines a portion of the passage 328 that is defined by the nipple 326 on the frame 140. A check valve 334 (depicted schematically in FIG. 4) is provided in the circuit between the pressure regulator 156 and the internal volume of the bottle 16. The check valve 334 prevents the beverage from flowing into the regulator when the pressure just downstream of the outlet of the nipple 256 on the regulator 158 is in equilibrium with the pressure inside the bottle 16. The check valve 334 is configured to open when there is about 2 psi to about 3 psi pressure differential across the check valve. In the depicted embodiment the check valve is a duck bill type check valve with the bill being disposed towards the bottle 16 in the circuit.

The operational sequence of the beverage dispensing assembly 10 will be described in more detail with reference to FIGS. 7-15. With reference to FIG. 7, the bottle assembly 12 is advanced into the dispenser assembly 14 by the consumer. With reference to FIG. 8, as the bottle assembly 12 is advanced towards the front plate 94 of the dispenser housing, the bottle retainer 152 rotates counter clockwise under spring pressure until the bottle assembly is fully advanced. The bottle retainer 152 then rotates back clockwise so that the catches 164 on the bottle retainer cooperate with the catches 32 on the cap 24 to retain the cap 24 and thus the bottle assembly 12. The locking lever 156 is shown in the unlocked position in FIG. 8.

With reference to FIG. 9, the locking lever 156 is advanced from the unlocked position to a locked position. The cartridge spike 332 advances into the gas inlet passage 54 formed in the cap 24 and opens the corresponding gas valve assembly by displacing the gas valve plug 72 from the seal 76. Accordingly, pressurized gas from the CO₂ cartridge 44 can enter the internal volume of the bottle 16.

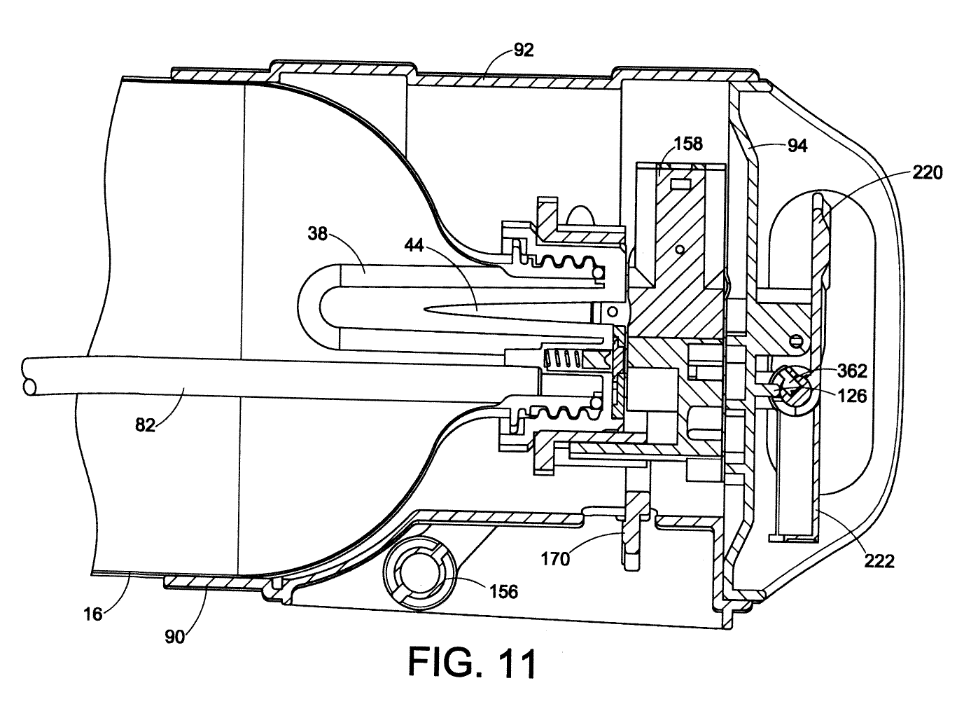

With reference to FIG. 10, which shows the same operational state as that shown in FIG. 9, when the locking lever 156 is moved from the unlocked position (shown in FIG. 8) to the locked position, the pointed edge 284 of the piercing pin 278 punctures the cartridge 44, thus providing communication between the cartridge 44 and the inside of the bottle 16. As also seen in FIG. 10, the beverage valve actuator 234, which is hollow and includes a passage 360 is inserted into the beverage outlet passage 52; however, the beverage outlet valve assembly is still in the closed position. The beverage valve actuator 234 also acts as a spike to unseal the beverage outlet passage 52.

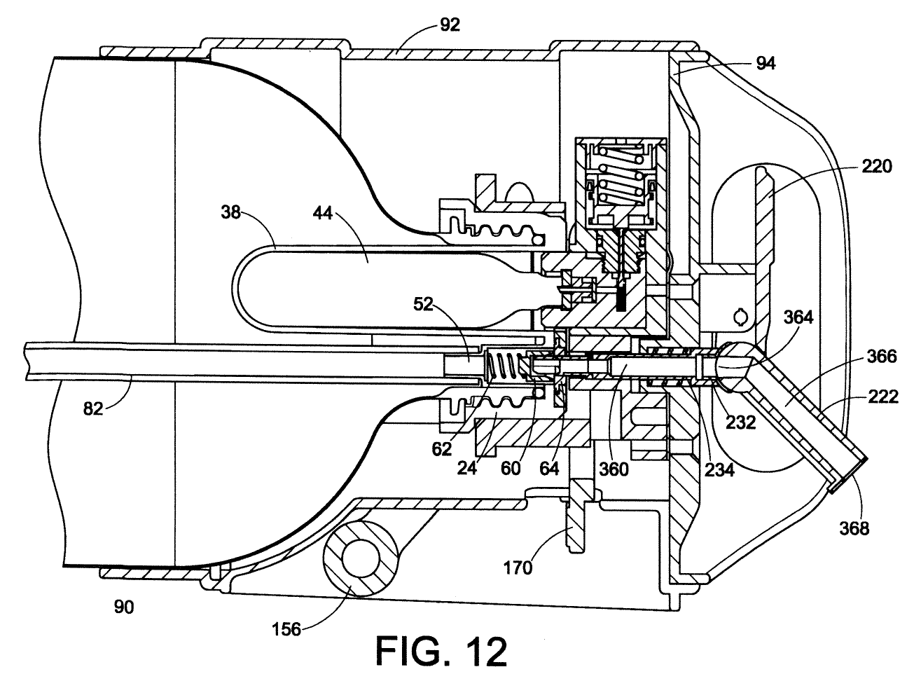

FIG. 11 shows the same state as FIGS. 8 and 9 while showing the spout 222 in a locked position. With the spout in the locked position, the tap handle 220 can not be rotated until the spout 222 is rotated outward (i.e. counterclockwise). Rotating the spout 222 outward aligns the pins 126 (also seen in FIG. 4) with channels 362 formed in the spout 222, thereby allowing the tap handle 220 to push the spout 222 towards the bottle cap 24.

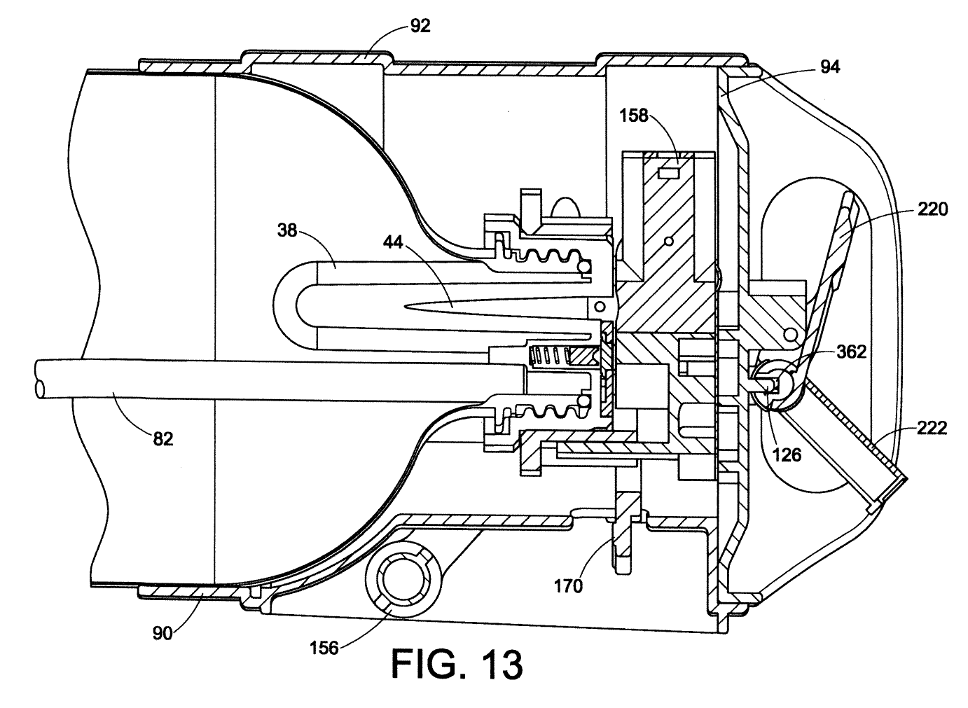

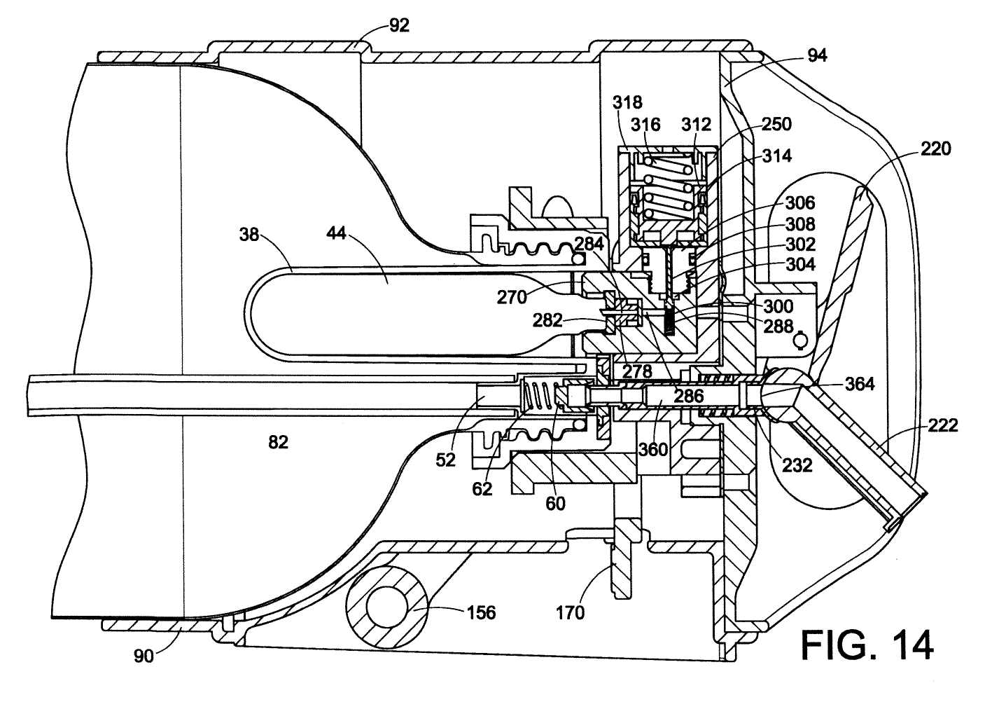

With reference to FIG. 12, the spout 222 has been rotated outward resulting in alignment of the beverage passageways. The passageway 360 defined in the beverage valve actuator 234 aligns with a beverage inlet 364 that is communication with a beverage passageway 366 and a beverage outlet 368 all formed in the spout 222. With reference to FIG. 13, the tap handle 220 is rotated clockwise to the dispense position resulting in the translation of the spout 222 and the beverage valve actuator 234 (FIG. 12) towards the bottle cap 24. The beverage valve assembly disposed in the cap is opened allowing beverage to flow under pressure from the bottle 16 to the spout 222. As shown in FIG. 13, the channel 362 in the spout 222 aligns with the pins 126 that extend outwardly from the face plate 94. With reference to FIG. 12, the beverage valve actuator 234 is translated towards the bottle cap 24 such that the plug 60 is moved away from the seal 64 opening the valve assembly allowing beverage to flow from inside the dip tube 82 through the beverage outlet passage 52 into the passage 360 formed in the beverage valve actuator 234 and into the beverage inlet 364 through the passage 366 and out the beverage outlet 368 of the spout 222.

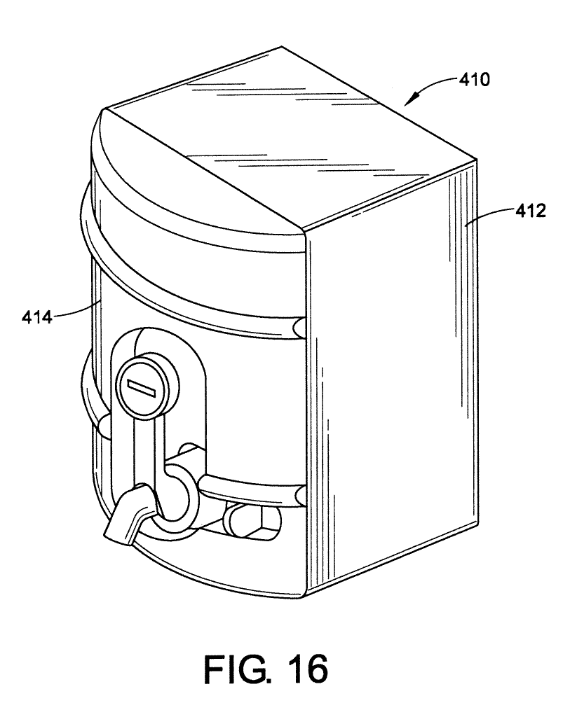

With reference to FIG. 15, when the contents of the bottle 16 have been fully dispensed or if a consumer simply wishes to remove the bottle assembly 12 from the dispenser assembly 14, the locking lever 156 is moved back into the unlocked position and the bottle retainer 152 is rotated counter clockwise by the consumer depressing the tab 170 so that the bottle assembly 12 can be removed from the dispenser assembly.

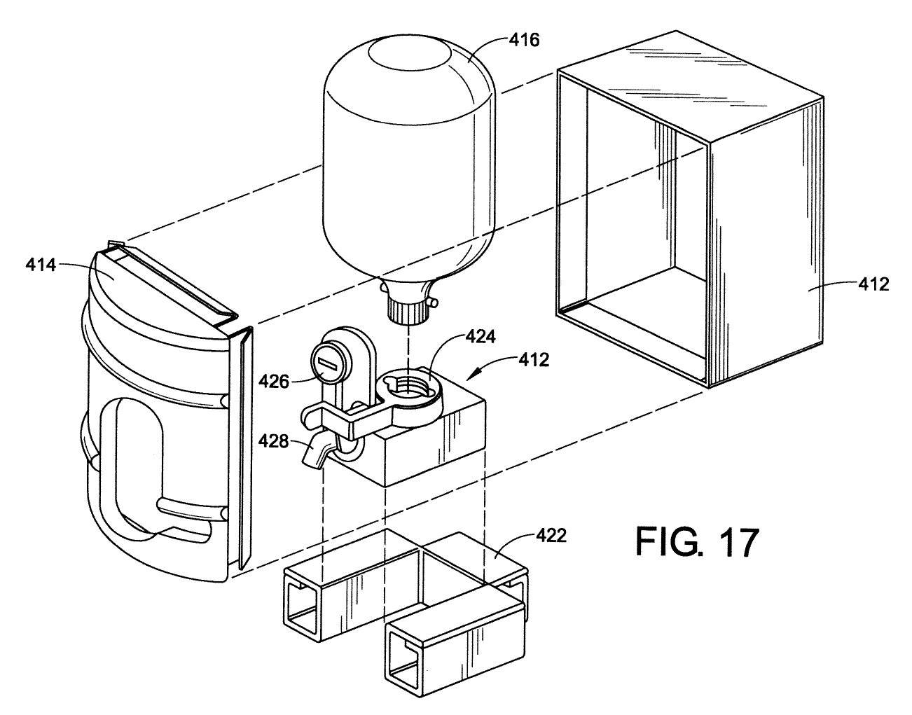

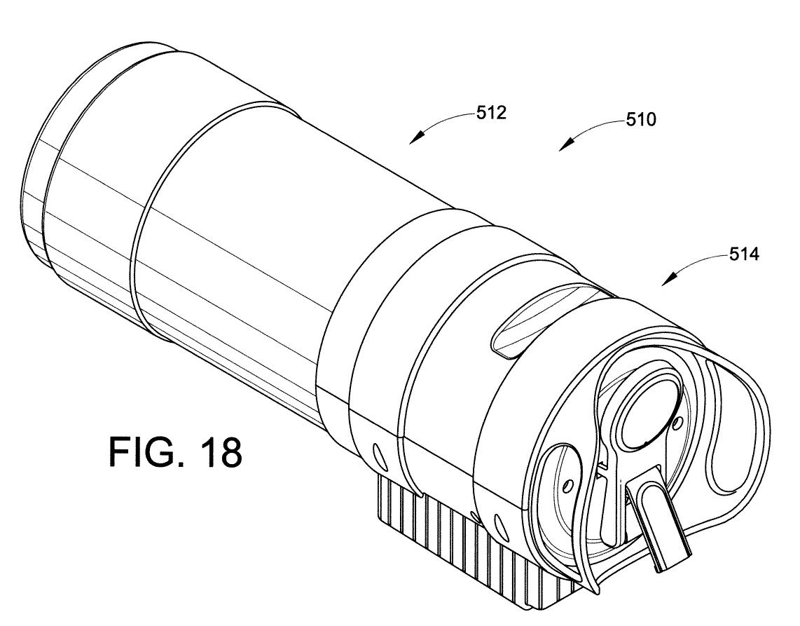

FIGS. 1-15 depict only one example of a beverage dispensing assembly with great particularity. Alternative embodiments were discussed throughout the description. The invention is not limited to simply the embodiment discussed above. For example, the beverage dispensing assembly 410 is shown in FIGS. 16 and 17. The beverage dispenser assembly includes a housing having a rear box-shaped portion 412 and cover 414. As seen in FIG. 17, the housing encloses a bottle for 416, a dispenser mechanism for 18, and a spacer 422. The bottle 416 can be a blow molded bottle similar to the one described above. The dispenser mechanism 412 includes a pressure source such as a cartridge similar to the cartridge 44 described above. A rotatable lock assembly 424 can be provided on the dispenser mechanism to prevent accidental dispensing of the product and to prevent dispensing of the product during shipment. A tap handle 426 and a spout 428 that are similar to those described above can also be provided with a dispenser mechanism for 418.

To dispense the beverage, the locking mechanism 424 is rotated which allows the bottle 416 to drop onto the dispenser mechanism which results in a seal that caps the bottle to be broken and a seal on the pressure cartridge to also be broken. This would result by gravity because of the weight of the beverage being contained in the bottle 416. The tap handle 426 can actuate a valve to allow for selective dispensing of beverage through the spout 428.

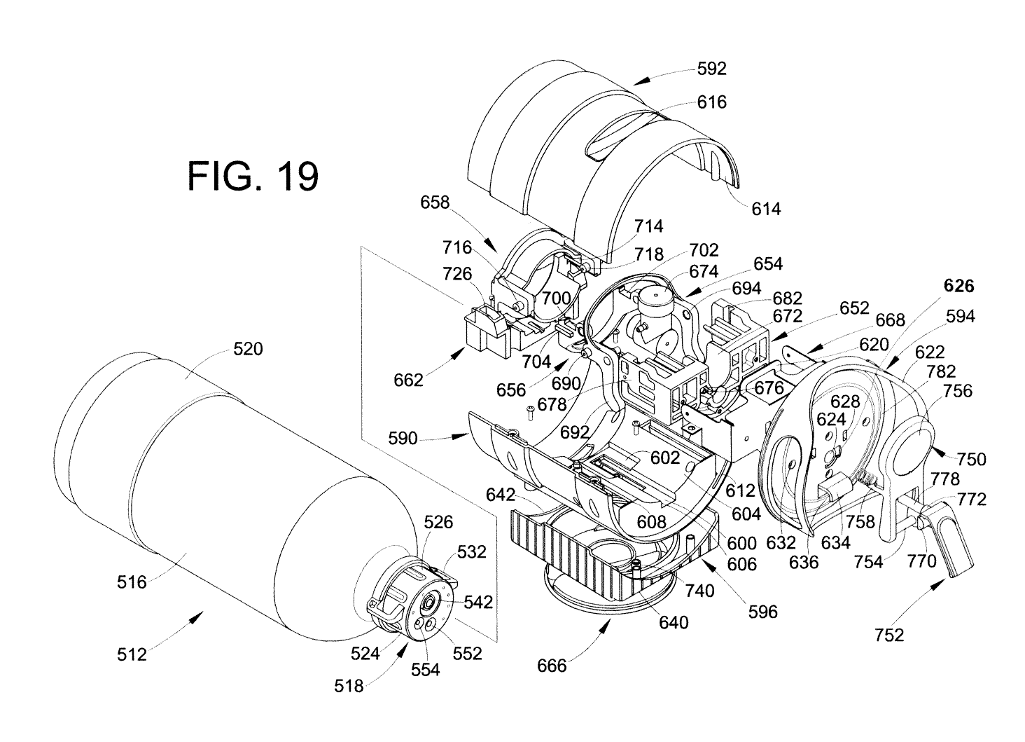

Another embodiment of a beverage dispensing assembly 510, also referred to as a beverage dispensing system, is depicted in FIG. 18. In this embodiment, the beverage dispensing assembly 510 includes a bottle assembly 512, which is very similar to the bottle assembly 12 depicted in FIG. 2, and a dispensing assembly, which is also somewhat similar to the dispensing assembly 14 depicted in FIGS. 1-15. The dispensing system 510 that is shown in FIG. 18 is also dimensioned and configured to fit into a conventional household refrigerator similar to the dispensing assembly that has been described above. The dimensions of the beverage dispensing assembly 510 shown in FIG. 18 can be the same as those that have been described for the beverages dispensing assembly 10 described with reference to FIGS. 1-15.

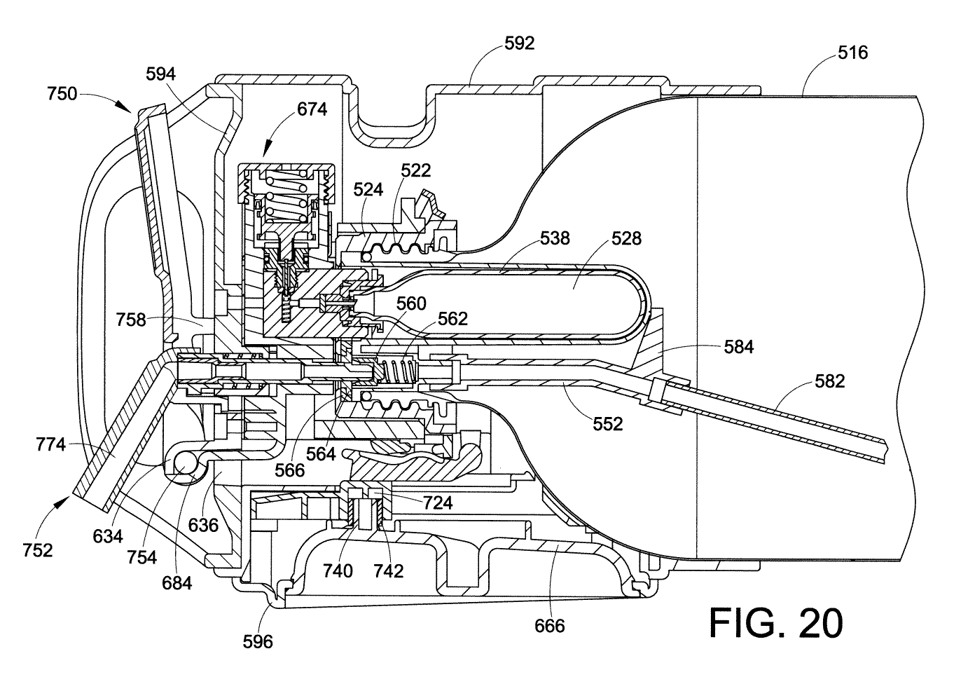

With reference to FIG. 19, the bottle assembly 512 includes a bottle 516 and a cap assembly 518. The bottle assembly 512 fits into the dispensing assembly 514 in much the same manner as the bottle assembly 12 fits into the dispensing assembly 14 that has been described above with reference to FIGS. 1-15. A consumer purchases the beverage dispensing assembly 510 and dispenses the beverage. After the beverage is dispensed and/or consumed, the consumer removes the empty bottle assembly 512 from the dispensing assembly 514 and buys a replacement bottle assembly to fit into the dispensing assembly.

The bottle 516 is the same as the bottle 16 that has been described above. A lower support 520 can receive a lower end of the bottle 516 and to provide further structural integrity to the bottle as well as provide a flat support surface.

The cap assembly 518 covers the opening through which the bottle 516 is filled with a beverage and retains the beverage in the bottle during shipment. The cap assembly 518 includes openings for dispensing the beverage and providing pressurized gas to the beverage.

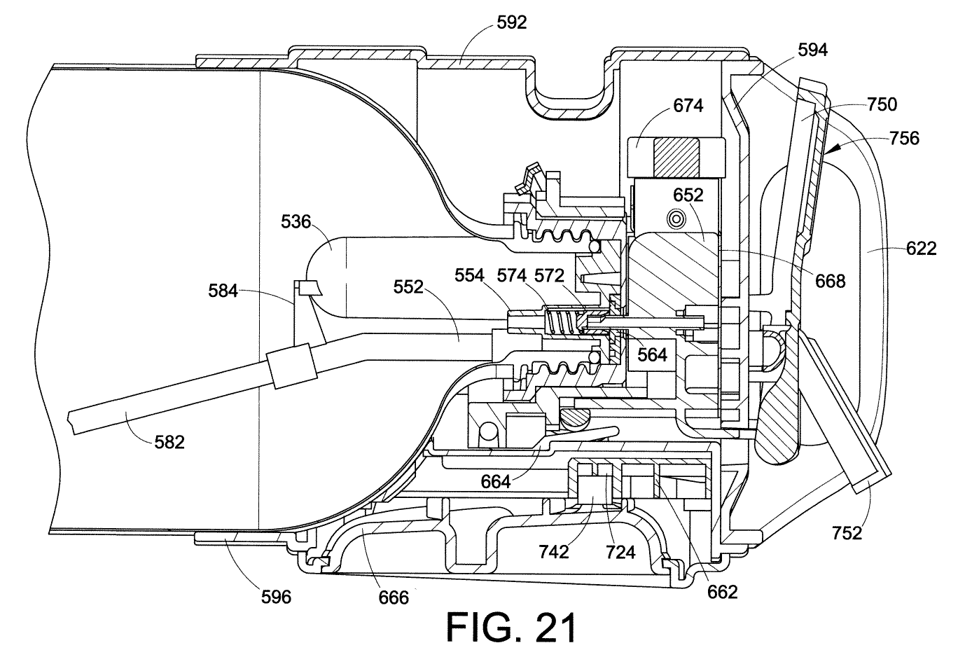

The cap assembly 518 generally includes a cap 524, a pressure source 528 (FIG. 20), and valve assemblies. The pressure source and the valve assemblies can also be located in the bottle, as opposed to in the cap assembly, if desired.

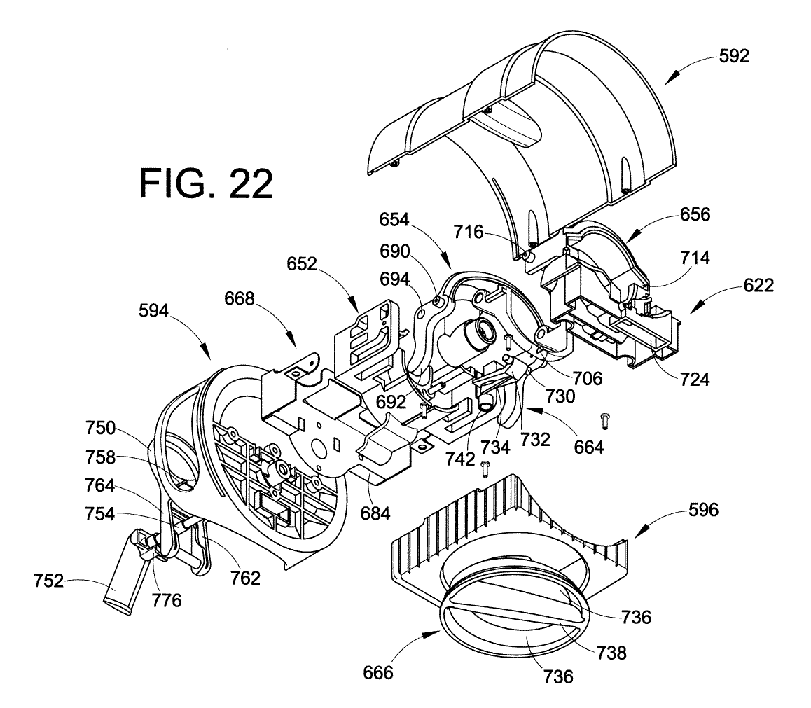

As seen in FIGS. 20 and 21, the cap 524 threads onto a threaded neck 522 of the bottle 516. The cap 524 can connect to the bottle in other manners, e.g. a bayonet connection, a snap fit or welding. The cap 524 includes a generally cylindrical side wall 526 having internal threads formed on an inner surface for threadingly engaging the threaded neck 522. With reference back to FIG. 19, the cap 524 also includes two catches 532 that extend outwardly from the cylindrical side wall 526 of the cap 524. The catches 532 are generally U-shaped bars having terminal portions that attach to the cylindrical side wall 526 to define an opening to facilitate attaching the bottle assembly 512 to the dispensing assembly 514.

The catches 532 are similar to the catches 32 that have been described above in that they align with a chord that is offset from the diameter of a circular end wall 534 of the cap and intersect the diameter of an opening 542 that leads to a cartridge receptacle 538. The cap 524 also includes the cartridge receptacle 538 that receives the pressure source 528 for the beverage dispensing assembly 510. The cartridge receptacle opening 542, which is one of three openings in the circular end wall 534, leads to a cavity that is defined by the cartridge receptacle. The cartridge receptacle 538 is offset from a rotational axis of the cap 524. The cartridge receptacle 538, similar to the cartridge receptacle 38 that has been described above, is configured to receive a conventional twelve ounce CO₂ cartridge, which serves as a pressure source. The cartridge receptacle 538 is closed with the exception of the opening 542 in the circular end wall 536 so that the internal compartment of the cartridge receptacle is not in communication with the bottle 516 when the cap 524 is connected to the threaded neck 522.

With reference back to FIG. 19, the cap 524 also includes a beverage outlet passage 552 and a pressurized gas inlet passage 554, similar to the passages formed in the cap 24 that has been described above. Each of these passages 552 and 554 is in communication with a separate opening formed in the circular end wall 534. Each passage 552 and 554 extends through the cap 524 such that each passage is in communication with the internal volume of the bottle 516, in a similar manner to the passages 52 and 54 that have been described above. Moreover, each passage can be sealed using foil or another sealing device such as rubber, plastic and the like to block the passages 552 and 554 to prevent the egress of beverage from the bottle during shipment. The foil, or other sealing device, can be referred to as a plug since it blocks the passage. The valve assemblies that are used to block the passages 552 and 554 as depicted in FIGS. 20 and 21 are the same as the valve assemblies that have been described to seal the passages 52 and 54, described above. With reference to FIG. 20, the beverage outlet valve assembly includes a plug 560 and a biasing member 562 that biases the plug into a closed position. The plug 560 acts against a seal 564 that is retained by a seal retainer 566. The seal retainer 566 can be welded to the cap 524. The spring 562 and the valve plug 560 are positioned inside the beverage outlet passage 552 and the spring 562 urges the plug 560 towards the seal 564. If desired, the spring can be removed and the plug 560 can be biased by the pressurized beverage in the bottle 516.

As seen in FIG. 21, the pressurized gas valve assembly includes a plug 572 that is biased by a spring 574 towards the seal 564. If desired, a separate seal can be provided for the pressurized gas valve assembly and the beverage valve assembly. The plug 572 seals against the seal 564 to prevent the beverage and gas from leaving the bottle 516 through the pressurized gas inlet 554 until the plug 572 is moved away from the seal. As seen in FIG. 21, the gas inlet passage 554 is also stepped to provide a seat for the spring 574. The spring can be removed and the plug 572 can be biased by the internal pressure of the pressurized beverage in the bottle; however, if pressure is lost inside the bottle the valve assembly may not seal. The gas valve assembly can also be replaced by foil or a similar device that acts as a plug.

A hollow dip tube 582 extends into the bottle 516 and is in communication with the beverage outlet passage 552. The beverage outlet passage 552 can bend downwardly at about a thirty degree angle from horizontal so that the dip tube 582 extends towards the rear lower end of the bottle 516 when the bottle is situated horizontally. A support 584 can attach to the cartridge receptacle 536 to provide some rigidity to the distal end of the beverage outlet passage 552. The dip tube 582 can be made from a flexible material similar to the dip tube 82 that has been described above.

The dispensing assembly 514 receives the bottle assembly 512. The bottle assembly 512 is designed to be removed from the dispenser assembly 514 after the beverage has been dispensed from the bottle, or earlier if desired, and replaced with a new bottle assembly. The dispenser assembly 514 includes more of the expensive components of the beverage dispensing system and is designed to be reused with many different bottle assemblies.

With reference to FIG. 19, the dispensing assembly 514 includes a housing, which in the depicted embodiment includes a lower housing 590, an upper housing 592, a face plate 594, and a base 596. The housing can take other configurations and can be made from a fewer or greater number of components. The housing that is depicted in FIG. 19 is made of plastic, but can be made of other materials.

The lower housing 590 is generally half-cylindrical, similar to the lower housing 90 described above. The lower housing 590 includes a central recess 600 that extends from a forward end of the lower housing rearwardly and leads into a larger rectangular recess 602 that is disposed at a rearward end of an upper platform 604 of the lower housing 590. A central slot 606 extends through the upper platform 604 in the central recess 600 and the rearward rectangular recess 602 from adjacent a rearward edge of the upper platform 604 and terminates before reaching the forward edge of the upper platform. The central slot 606 is axially aligned with the central axis of the housing. The lower housing 590 also includes outer axial slots 608 that are spaced from the central slot 606.

The upper housing 592 is generally half-cylindrical in shape so that when it is connected to the lower housing 590 a generally cylindrical housing is formed. The upper housing 592 attaches to the lower housing 590 in much the same manner as the upper housing 92 attaches to the lower housing 90 in the dispenser assembly that was described above. Accordingly, further description of how the two components attach to one another is not provided. The upper housing 592 includes radial recesses 614 that are similar to radial recesses 612 in the lower housing 590 for attaching the face plate 594 to the lower housing and the upper housing. The upper housing 592 also includes a recess 616 where a user can insert his hands when dispensing beverage from the dispensing assembly as well as when loading a new bottle assembly 512 into the dispenser assembly 514. The finger recess 616 is disposed on the upper surface of the upper housing 592.

The face plate 594 is generally circular. The face plate includes small ribs 620 that fit into the axial slots 608 and 612 formed in the lower housing 590 and the upper housing 592, respectively. Handles 622 are also provided on opposite sides of a diameter of the circular face plate 594. The handles 622 are similar to the handles described with reference to the face plate 594 above. The face plate 594 also includes a central opening 624. Rectangular openings 628 are positioned above the central opening 624 and are equidistantly spaced from the central opening 624. Fastener openings 632 are also found on the face plate. The face plate 594 also includes an extension 634 that is disposed below the central opening 624 and is bisected by a diameter that runs through the central opening. The extension 534 is similar to a flange having a L-shape that is projected downwardly. A rectangular opening 636 is disposed beneath the extension 634.

The base 596 is generally a box-shaped component having forward and rearward side walls 640 that are formed to have a saddle shape for receiving the lower housing. A circular opening 642 is formed in a lower wall of the base 596.

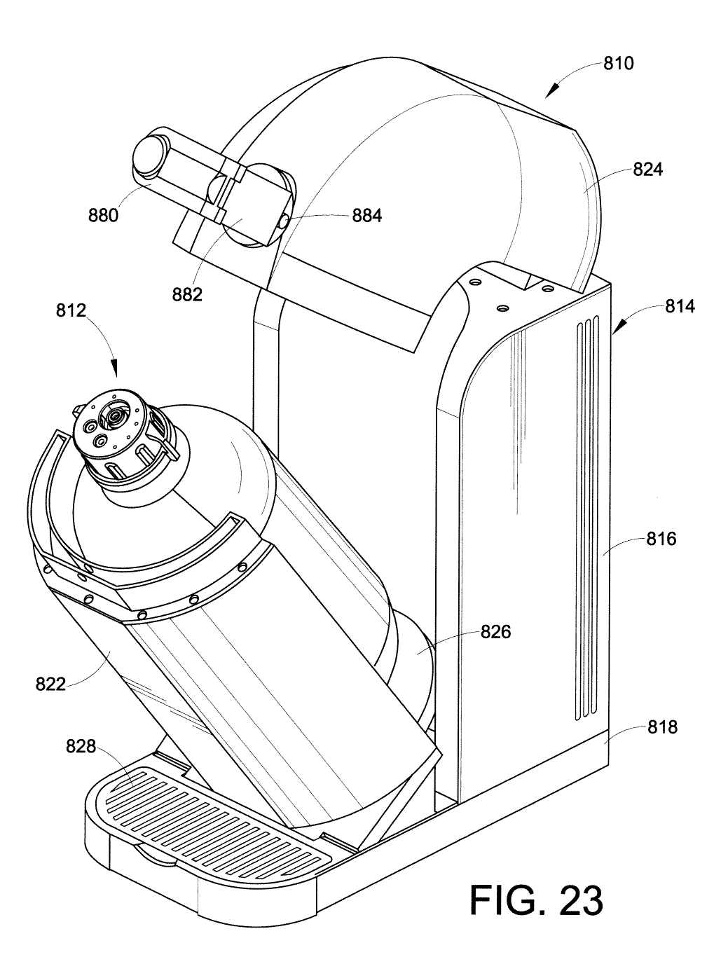

With reference to FIG. 19, a frame 652, a connector 654, a bottle retainer 656, an alignment bracket 658, a slide 662, a lever 664 (visible in FIGS. 21 and 22), and a knob 666 all cooperate with one another to attach the bottle assembly 512 to the dispenser assembly 514 so that a beverage can be dispensed. The knob 666 acts as a movable handle component that is operably connected to the bottle assembly to draw the bottle assembly toward the gas spike and the beverage spike.

As seen in FIG. 21, a frame cover 668 is sandwiched between the face plate 594 and the frame 652 in a similar manner as in the embodiment described above. The frame 652 attaches to the face plate 594 and provides a structure to allow the moving components of the dispenser assembly to bring the bottle assembly 512 into engagement with the pressure source and the dispensing system of the beverage dispensing assembly. With reference to FIG. 19, the frame 652 includes a curved recess 672 that receives a pressure regulator 674 (that is very similar to the pressure regulator 158 described above and therefore further description will not be provided). The frame also includes a nipple 676 to allow for the connection of a hose 678 (shown in phantom) that is in communication with the pressure regulator 674 to allow for high pressure gas that enters the pressure regulator 674 to be released into the internal compartment of the bottle 516 at a lower pressure after traveling through the pressure regulator. The frame 652 also includes vertical slots 682 on opposite sides of the frame, which is similar to the frame that has been described above with reference to FIGS. 1-15. The frame 652 also includes a lower tongue 684 (FIGS. 20 and 22) that extends from a lower end of the frame. The tongue 684 extends through the lower rectangular opening 636 formed in the face plate 594 and cooperates with the extension 634 formed on the face plate in a manner that will be described in more detail below.

The connector 654 is a generally U-shaped member. The connector 654 includes outwardly protruding posts 690 that are received in the vertical slots 682 of the frame 652. L-shaped cam arms 692 depend downwardly from where the outwardly protruding posts are found on the connector. The connector 654 also includes openings 694 at the top of each cam arm.

The bottle retainer 656 is also a generally U-shaped component. As opposed to the connector 654, the U-shaped bottle retainer 656 extends so that the U-shaped portion extends downwardly. Loops 700 are formed at opposite terminal ends of the bottle retainer 656. Hooks 702 are spaced rearwardly with respect to the loops 700 (per the orientation where the face plate 594 is the front of the assembly). The loop 700 provide a means for attaching the bottle retainer 656 to the alignment bracket 658. Ridges 704 extend from the outer side of the bottle retainer between the end of each hook 702 and the corresponding loop 700. With reference to FIG. 22, a spring pin 706 is formed along an axis of symmetry of the U-shaped bottle retainer. The spring pin 706 receives a compression spring (not shown) that biases the bottle retainer 656 into an open position with respect to the alignment bracket 658. In the depicted embodiment, the bottle retainer 656 is biased towards the face plate 594 and away from the alignment bracket 658. The connector can be biased open in other manners, e.g. a torsion spring.

As seen in FIGS. 19 and 22, the alignment bracket 658 is a generally cylindrical component having a generally circular opening that leads into offset slots 714. The alignment bracket 658 is very similar in configuration with the alignment bracket 154 that is described with reference to FIGS. 1-15. The slots 714 are configured to receive the handles 532 of the cap assembly 518 when the bottle assembly 512 is inserted into the dispenser assembly 514. The alignment bracket 658 also includes a pair of outwardly protruding posts 716 that are received in the openings 694 of the connector 654 for attaching the connector 654 to the alignment bracket 658. The alignment bracket also includes inwardly protruding posts 718 that are received in the loops 700 of the bottle retainer 656.

With reference to FIG. 22, the slide 662 includes a transverse notch 724 that is elongated in a direction that is transverse to the direction of travel of the slide 662. The transverse notch 724 allows the knob 666 to cooperate with the remainder of the components so that when the knob is rotated the pressure regulator 674 comes into fluid communication with the internal compartment of the bottle 516. With reference back to FIG. 19, the slide 662 also includes openings 726 that are configured to receive the cam arms 692 of the connector 654.

When the dispenser is assembly 514 is assembled, the slide 662 is disposed below the lower housing 590 and the cam arms 692 of the connector 654 extend through the outer axial slots 608 formed in the lower housing thus connecting the connector 654 to the slide 662. The slide 662 moves in an axial direction in response to rotation of the knob 666.

With reference to FIG. 22, the lever 664 includes an integrally formed axle 730 that rests in an appropriate recess formed in the lower housing 590. The lever 664 includes a chamfered rear contact surface 732 that is contacted by the slide 662 when the slide moves transversely towards the lever. The lever 664 also includes a rib 734 that extends downwardly from the lever and is aligned with the axis in which the slide moves.

The knob 666 is generally circular in configuration. The knob includes two recesses 736 to define a handle 738 that is easily gripped by a user of the device. A pin 740 extends upwardly from an inner surface of the knob 666.

Rotation of the knob 666 results in the pin 740 and a bushing 742 (received on pin 740) moving from an outer end of the notch 724, with respect to a central axis of the dispenser assembly, towards an inner end of the notch. This results in the slide 662 moving transversely towards the face plate 594. The slide 662 contacts the lever 664, which presses against the bottle retainer 656 rotating the bottle retainer so that the biasing force of the spring 708 is overcome and the hooks 702 engage the catches 532 of the cap assembly 518. Further movement of the slide 662 results in the over center cam arms 692 riding over the appropriately shaped openings 726 far enough so that an over-center type latch is formed between the connector 654 and the slide 662.

With reference back to FIG. 19, the dispensing assembly 514 also includes a tap handle 750 and a spout 752 that each attach to the face plate 594 of the housing. The tap handle 750 is rotated with respect to the face plate 594 to dispense a metered portion of a pressurized beverage, or other liquid, from the bottle 516 through the spout 752. The tap handle 750 includes an integrally formed axle 754 at a lower end and a contact surface 756 disposed at an upper end. The contact surface 756 can be depressed so that the tap handle 750 rotates about the integral axis 754 to dispense beverage. The integral axis 754 is captured by the extension 634 on the face 594 plate and the tongue 684 of the frame 652, as more clearly seen in FIG. 20. The tap handle 750 also includes rearwardly extending barbs 758 that are received in the rectangular openings 628 to limit movement of the contact surface 756 of the tap handle away from the face plate 594. More clearly seen in FIG. 22, the tap handle 750 also includes recesses 762 formed on a rear surface of legs 764 that are interconnected by the integral axis 754. The recesses 762 cooperate with the spout 752 in a manner that will be described in more detail below.

With continued reference to FIG. 19, the spout 752 includes shoulders 770 having a rounded surface that allows the spout 752 to be trapped between the recesses 762 formed on a rear surface of the tap handle 750 and the face plate 594. A central hollow fitting 772 extends rearwardly from the shoulder 770 and is in fluid communication with a hollow outlet passage 774 (FIG. 20) that extends forwardly from the shoulder. As more clearly seen in FIG. 22, the spout 752 also includes a locking finger 776 that is received in the crescent-shaped opening 626 formed in the face plate 594. As can be seen in FIG. 19, the crescent-shaped opening 626 includes a wider opening adjacent the three o'clock position with respect to the central opening 624. Accordingly, the spout 752 can be rotated counterclockwise so that the locking finger 776 no longer engages a rear surface of the face plate 594 so that the spout can be removed from the assembly and cleaned.

A rigid tube 778 fits onto the hollow fitting 776 and extends into the dispensing assembly and into the frame 652 (see FIG. 20). A spring 782 biases the rigid tube 778, the spout 752, and thus the tap handle 750 away from the face plate 594. With reference to FIG. 20, to dispense a beverage a user presses against the contact surface 756 which results in the tap handle 750 rotating towards the face plate 594 about the integral axle 754. This rotational movement results in the rigid tube 778 pressing against the beverage valve assembly thus opening the outlet passage to allow beverage to flow from an internal compartment of the bottle 516 out the outlet passage 774 of the spout.

As discussed above the beverage that is dispensed is pressurized. The pressure regulator 674 receives pressurized gas from the cartridge 528 received in the cartridge receptacle 538 at a higher pressure and delivers pressurized gas at a lower pressure to the internal compartment of the bottle 516.

With reference to FIG. 20, when the knob 666 is rotated thus bringing the bottle assembly 512 towards the dispenser assembly 514, the gas cartridge in the cartridge receptacle 538 is also pierced in much the same manner as the embodiment described above. In the depicted embodiment, a seal can be provided and shipped with the bottle assembly 512 that is pierced by the piercing pin of the pressure regulator 674. High pressure gas exits the gas cartridge and enters the pressure regulator 674 and is dispensed through the outlet nipple 676 traveling through the hose 678 and into a passage formed in the frame 652. The pressurized gas enters the bottle 516 to propel the beverage from the bottle (when the beverage valve assembly is open) as well as to maintain the desired carbonation in the bottle after some of the contents of the bottle have been dispensed.

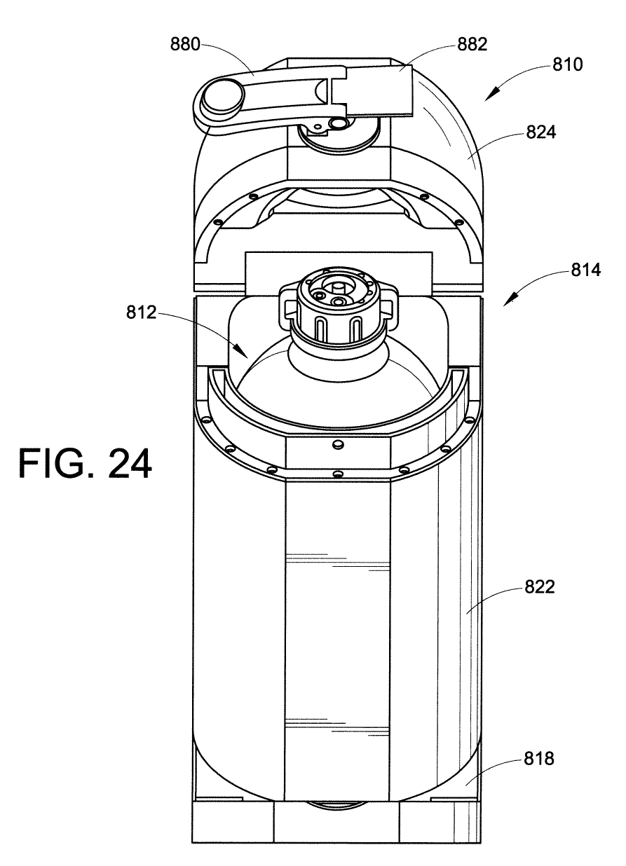

With reference to FIG. 23, an alternative embodiment of a beverage dispenser system 810 is disclosed. The system 810 includes a bottle assembly 812, which is similar to the bottle assembly 12 described with reference to FIGS. 1-15 and therefore further description will not be provided, and a dispenser assembly 814.

The dispenser assembly 814 includes a housing made up of a rear housing section 816, a base 818, a front door 822 and a lid 824. The rear housing section 816 connects to the base 818. The front door 822 and the lid 824 both pivot with respect to the stationary rear housing section 816 and the base 818. A platform 826 connects to the front door 822 and rotates therewith. The platform 826 supports the bottle assembly 812 during loading of the bottle assembly into the dispenser assembly 814. The base 818 can be formed to include a recess covered by a drip tray 828.

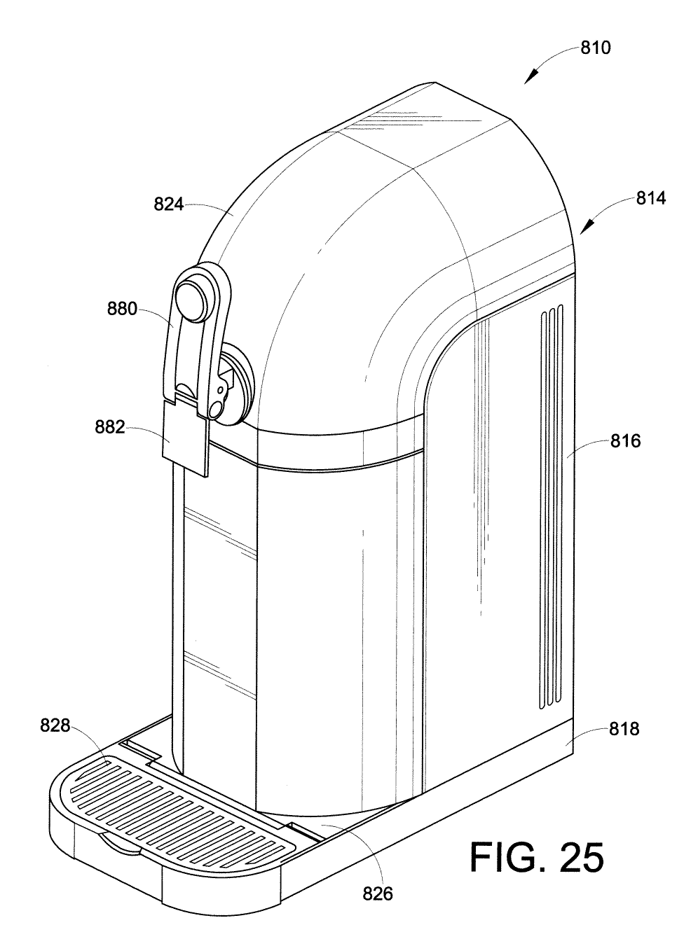

FIGS. 23 and 24 depict the door 822 and the lid 824 in an open position. When these components are in the open position, the bottle assembly 812 can be loaded into and removed from the dispenser assembly 814. As most clearly seen in FIG. 24, when the door 822 is moved into the open position, the door does not advance beyond the plane of the sidewalls when opened. In other words, the door 822 pivots about a horizontal axis in contrast to the door swinging in a vertical axis towards one of the sides of the stationary rear housing 816. Such a configuration facilitates the loading and unloading of the bottle assembly 812 into the dispenser assembly 814 while limiting the amount of spaced required when one is attempting to load or unload a bottle assembly 812 from the dispenser assembly 814. If the door were to rotate about a vertical axis, clearance would need to be provided to the sides of the stationary housing section 816. By having the front door 822 pivot about a horizontal axis, the path traversed by the front door is much the same path that is traversed when one places a glass on the drip tray 828 to dispense a beverage from the system 810. This path will be typically left open on the countertop or table that supports the assembly 810. Moreover, the configuration shown in FIGS. 23-25 does not require repositioning of the dispensing system 810 in order to load or unload a bottle assembly 812 from the beverage dispenser assembly 814.

The lid 824 also rotates about a horizontal axis. By having the lid 824 rotate about a horizontal axis and the front door 822 rotate about a horizontal axis, the distance that the lid must travel with respect to the rear housing is limited to provide the required clearance for removing the bottle assembly 812 from the dispenser assembly 814. Accordingly, the dispenser system 812 can be conveniently located on a countertop underneath wall mounted cabinets and the bottle assembly 812 can be loaded into the dispenser assembly 814 while the dispenser system 810 remains underneath the wall mounted cabinets. Similarly, when the lid 824 is in the open position, the lid does not advance beyond the plane defined by the sidewalls of the stationary section 816.

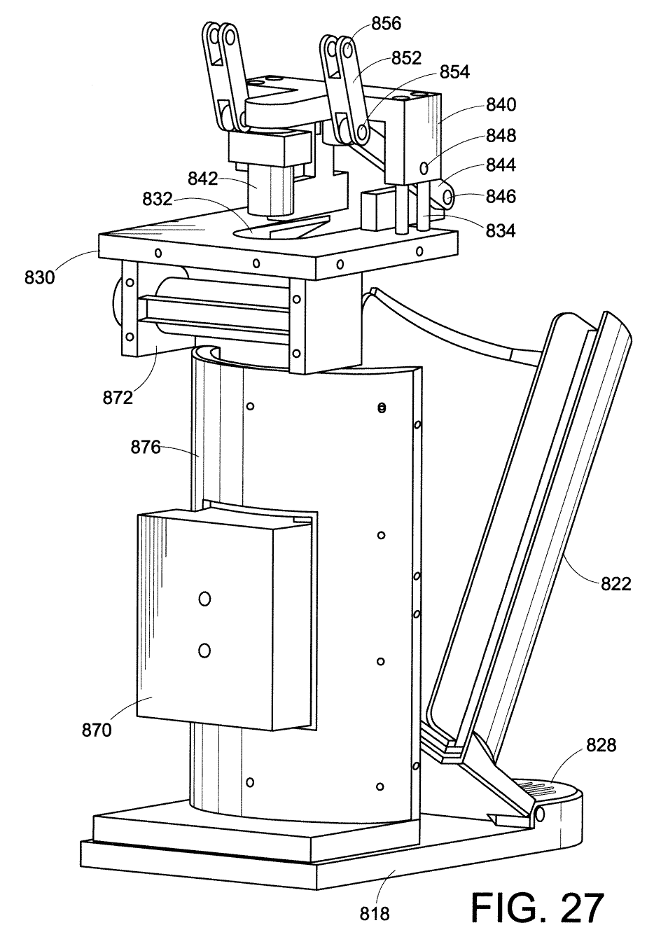

With reference to FIG. 26, some of the internal components of the beverage dispensing system shown in FIG. 23 are disclosed. The system includes a frame 830 that attaches to the rear housing section 816 at an upper end thereof. The frame 830 cantilevers forward from the rear housing section 816. The frame includes a U-shaped slot 832 that receives the cap of the bottle assembly 812. Vertical guides 834 extend upwardly from the frame.

A piercing block 840 is received on the vertical guides 834 so that the pierce block can move up and down on the vertical guides. The piercing block 840 includes a beverage passage and a gas passage, which are not visible in the figures. The gas passage is in fluid communication with a pressure regulator 842, which is similar to the pressure regulators described above in that it receives pressurized gas from a gas cartridge in the bottle assembly 812 of a first pressure and delivers pressurized gas to the internal compartment of the bottle assembly at a lower pressure. The gas passage inlet may include a valve that is normally closed and is opened when the pierce block 840 is brought towards the bottle assembly 812 to in the bottle assembly.

A lower linkage set 844 is pivotally connected to the frame 832 at a pin 846. Each linkage of the lower linkage set 844 also includes a slot (not visible) that receives a pin 848 that connects the linkage set 844 to the piercing block 840. Each linkage of the lower linkage set 844 connects to a respective linkage of an upper linkage set 852 at a pin 854. An upper end of each linkage of the upper linkage set 852 includes an opening 856 that allows this linkage set to pivotally attach to the lid 824 (FIG. 23). The lid 824 also attaches to the rear housing section 816 via a pin (not visible) that is received in an opening 858 formed in the rear housing section 816. As the lid 824 is rotated from the open position towards the closed position the linkage sets 852 and 844 cooperate with the frame 830 to move the piercing block 840 towards the bottle assembly 812. The piercing block 840 includes a piercing pin (similar to the piercing pin described above) that pierces the gas cartridge in the bottle assembly 812. The piercing block 840 also includes spikes that pierce the gas valve assembly and the beverage valve assembly, respectively. A biased lid lock 862 can cooperate with the lid 824 to retain the lid in a closed position. In this embodiment, it is the lid 824 that acts as a movable handle component that is operably connected to the beverage spike and the gas spike to move each spike towards the bottle assembly.

The beverage dispensing system 810 can also include a chilling device 870 that can be used to chill the contents of the bottle assembly. In the depicted embodiment, the chilling device 870 is a Peltier device, but other refrigeration type devices including ones that use compressors can also be used. A fan 872 attaches to the rear housing section 816. An aluminum back panel 876 connects to the chilling device 870 so that the contents of the bottle 812 can be cooled. The front door 822 can be made from an insulated material such as an insulating plastic.

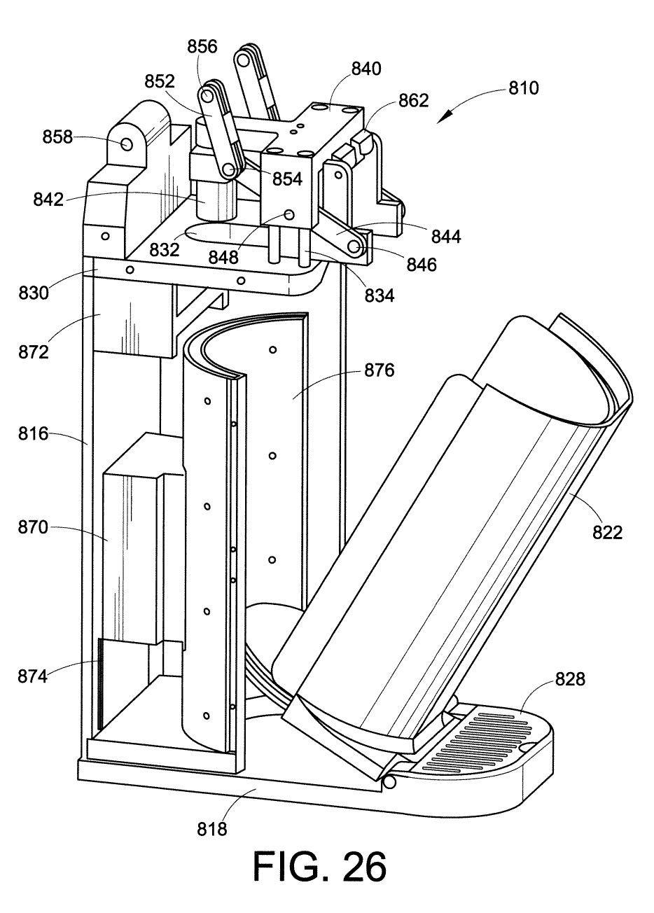

With reference back to FIG. 23, the dispensing system 810 includes a tap handle 880 and a spout 882. As seen when comparing FIG. 23 to 25, the tap handle 880 and the spout 882 can rotate from an unlocked position (shown in FIG. 23) to a locked position (shown in FIG. 25). The spout 822 includes a beverage outlet passage 884 that is in fluid communication with the beverage passage found in the piercing block 840 so that when the tap handle 880 is rotated towards a dispense position, which can either be by pulling or pushing, this actuates the beverage valve actuator in the bottle assembly to open to allow fluid to be dispensed from the system. The beverage passage in the sliding piercing block 840 and the outlet passage 884 of the spout 882 can be connected via a hose or via a direct connection. Similarly, the pressure regulator 842 can also be in fluid communication with the internal compartment of the bottle assembly 812 through a hose or through a direct connection in the piercing block 840.

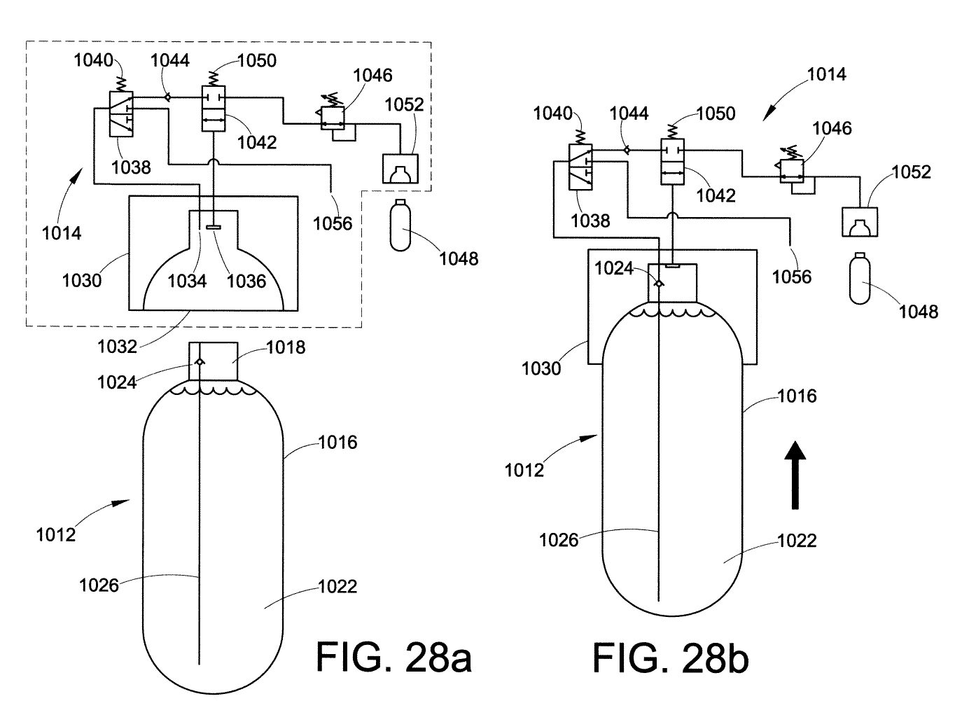

The embodiment depicted in FIGS. 1-15 and 18-22 depict the bottle assembly being brought towards the gas spike and the beverage spike through the movement of a movable handle component (e.g. handle 156 and knob 666). The embodiment depicted in FIGS. 23-27 depict the gas spike and the beverage spike being brought towards the bottle assembly through the movement of a movable handle component (e.g. lid 824 and/or tap handle 880). The embodiments depicted in FIGS. 1-15 and 18-22 can be modified to move the spikes toward the bottle assembly through the operation of a movable component in a similar manner to the embodiment shown in FIGS. 23-27.

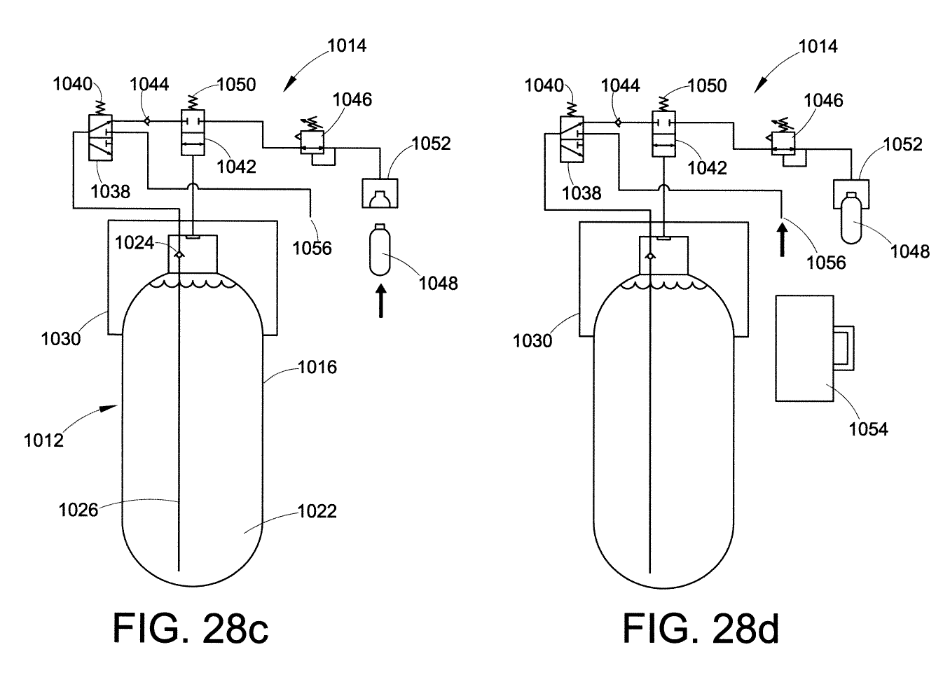

With reference to FIGS. 28a-d, an alternative embodiment of a beverage dispensing system is schematically depicted. In the embodiment shown in FIGS. 28a-d, a bottle assembly 1012 (similar to bottle assembly 12) cooperates with a dispenser 1014. The bottle assembly 1012 includes a bottle 1016 and a cap 1018 that closes an internal compartment 1022 of the bottle. A one-way check valve 1024 is disposed in the cap 1018 and is in communication with a dip tube 1026 that extends into the internal compartment 1022.

In the embodiment depicted, the dispenser 1014 includes a housing 1030 that defines a vessel receptacle 1032. A dual-purpose gas and beverage spike 1034 is disposed in the vessel receptacle 1032. A plunger 1036, or similar actuator, is also disposed in the vessel receptacle 1032. The gas/beverage spike 1034 is in fluid communication with a two-way two-position valve 1038 biased into an initial position by a spring 1040. The plunger 1036 mechanically operates a two-position valve 1042 that is in communication with the two-way two-position valve 1038 separated by a one-way check valve 1044 that checks fluid from flowing from the two-way two-position valve 1038 toward the two-position valve 1042. A pressure regulator 1046 (similar to the pressure regulators described above) is also in communication with the valves 1038 and 1042 as well as a pressure source 1048, which in the depicted embodiment is a gas cartridge similar to the gas cartridges described above. The gas cartridge 1048 is received in a cartridge receptacle 1052 that includes a piercing mechanism similar to the piercing mechanisms described above. Different than the embodiments described above, the gas cartridge 1048 is not received in the bottle 1016. The two-position valve 1042 is biased toward a blocked position by a spring 1050.

With reference to FIG. 28b, the bottle assembly 1012 is brought towards the dispensing assembly 1014, or vice versa, which results in the plunger 1034 actuating the two-way valve 1042 to position it to an open state. The gas/beverage spike 1034 opens the one-way check valve 1024. Pressurized beverage in the internal compartment 1022 is precluded from escaping past the check valve 1044.

With reference to FIG. 28c, the gas cartridge 1048 is loaded into the cartridge receptacle 1052 to supply pressurized gas to the internal compartment 1022. The cartridge 1048 is pierced when loaded into the receptacle 1052.

With reference to FIG. 28d, the two-way two-position valve 1038 is moved into its second position so that beverage is dispensed into a dispensing vessel 1054. The pressurized gas from the pressure source 1048 is enough to propel the beverage out of the internal compartment 1022 and through the lines to an outlet 1056. When the two-way two-position valve 1038 moves back to a biased initial position, the pressure source 1048 recharges the pressure in the internal compartment 1022 of the bottle 1016 to the pressure at which the pressure regulator 1046 delivers pressure, which is approximately 15 psig.

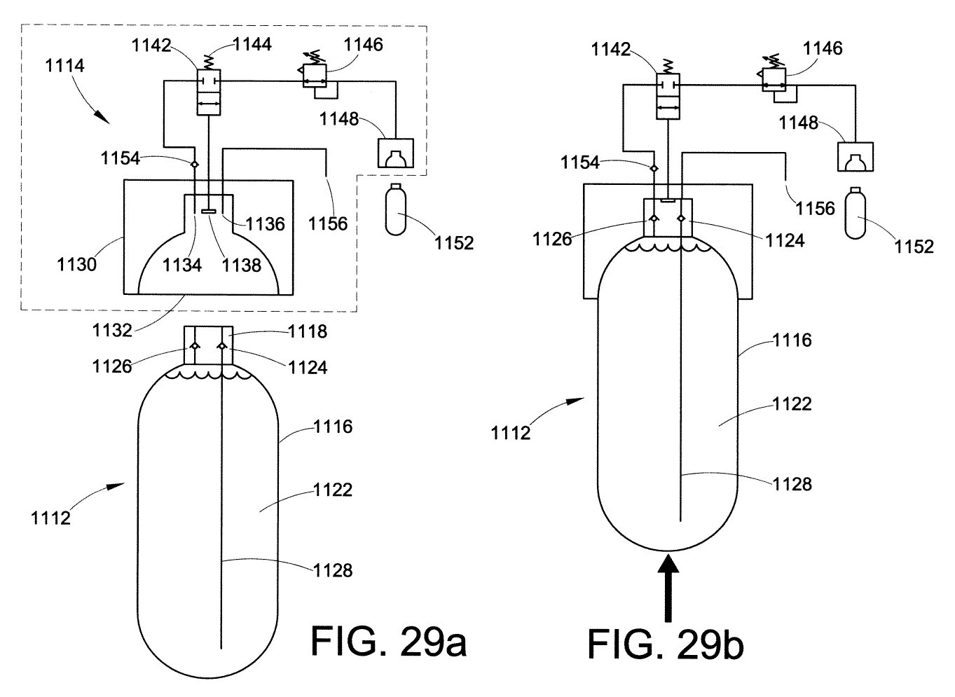

With reference to FIGS. 29a-d, an alternative embodiment of a beverage dispensing system is shown. In this embodiment, a bottle assembly 1112 cooperates with a dispensing assembly 1114. In this embodiment, the bottle assembly includes a bottle 1116 closed by a cap 1118 that closes off an internal compartment 1122. The cap includes a first check valve 1124 and a second check valve 1126. A dip tube 1128 is also disposed in the internal compartment 1122 and is in communication with the first check valve 1124.

The dispensing assembly 1114 includes a housing 1130 that defines a vessel receptacle 1132. A gas port (spike) 1134 and a beverage port (spike) 1136 are disposed in the receptacle 1132. A plunger 1138 is also disposed in the vessel receptacle 1132. A normally closed two-position valve 1042 is operated by the plunger 1138 and is biased into a closed position by a spring 1144. A pressure regulator 1146 is in fluid communication with the valve 1142 and a cartridge receptacle 1148. The gas check valve 1126 in the cap 1118 and the valve 1142 are also in fluid communication.

With reference to FIG. 29b, when the bottle assembly 1112 is moved towards the dispensing assembly 1114, or vice versa, the beverage port (spike) 1136 opens the first check valve 1124.

With reference to FIG. 29c, when the cartridge 1152 is loaded into the cartridge receptacle 1148, the cartridge is pierced and pressurized gas is delivered to the pressure regulator 1146 and into the internal compartment 1112 of the bottle 1116 through the two position valve 1144 and the check valves 1154 and 1126.

With reference to FIG. 29d, the beverage check valve 1124 is opened to dispense beverage out an outlet 1156 and into a vessel 1158.

In lieu of providing a one-way check valve and operating the one-way check valve as shown in FIG. 29d, an on/off spigot can be provided and the beverage port 1136 can be a spike that opens the check valve 1124 when the bottle assembly 1112 is inserted into the dispensing assembly 1114, or vice versa.

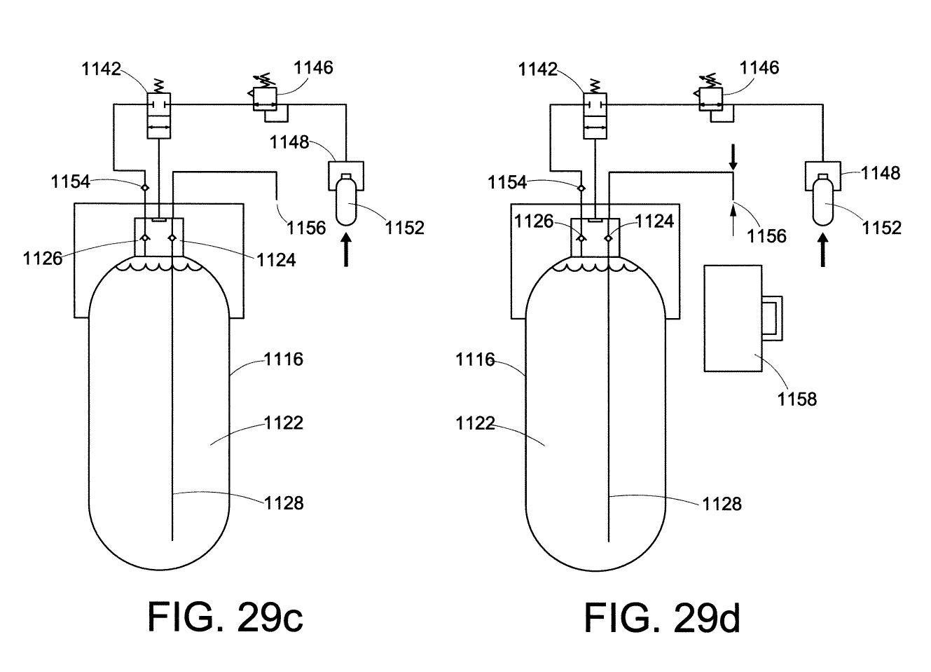

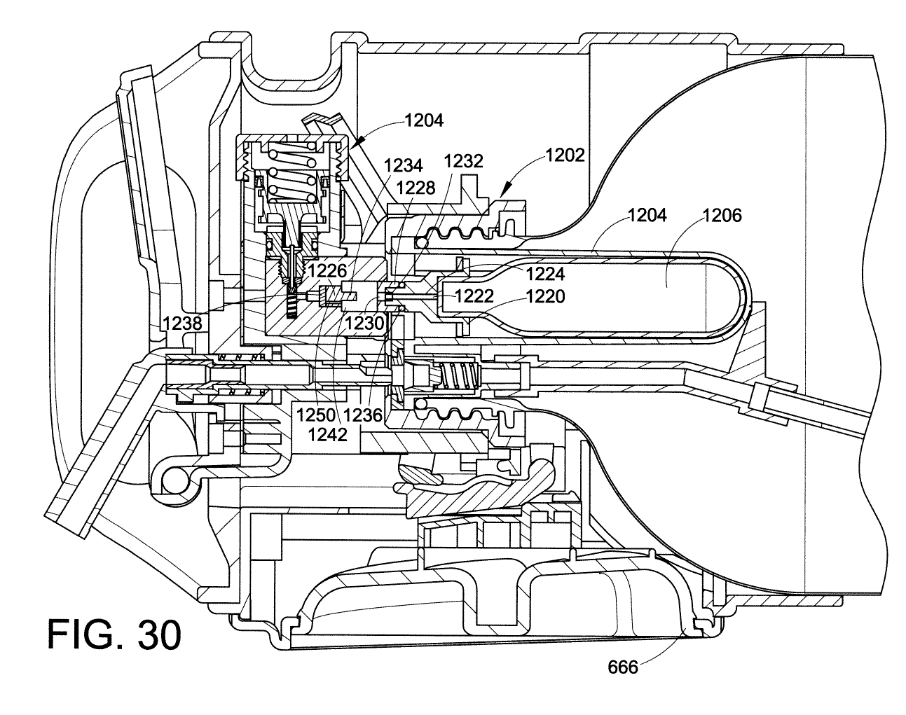

FIGS. 30 and 31 disclose an alternative embodiment of the beverage dispensing assembly where the seal between the pressurized gas source and the pressure regulator becomes a disposable component. This can better maintain the seal between the pressurized gas source and the pressure regulator as compared to placing the seal in the pressure regulator and re-using the seal over and over. Where the seal is found in the pressure regulator, the seal can deform over time, which can result in leakage between the pressurized gas source and the pressure regulator. This is undesirable.

FIG. 30 depicts a beverage assembly having the same components and configuration as the beverage assembly described with reference to FIGS. 18-22, except for the cap assembly 1202 and the pressure regulator 1204. The cap assembly 1202 threads onto the bottle similar to the cap assembly 18 described above. The cap assembly includes a gas cartridge receptacle 1204 that receives a gas cartridge 1206. The gas cartridge 1206 can be brought towards the pressure regulator 1204 in any of the manners described above, e.g. through movement of a handle 156 described above or through movement of a knob 666 which is similar to the knob shown in FIG. 19. The manner in which the gas cylinder 1206 is brought towards the pressure regulator 1204 is more particularly described above. Alternatively, the pressure regulator 1204 could be brought towards the gas cylinder 1206.

In the embodiment depicted in FIGS. 30 and 31, a gas cylinder cap 1220 threads onto the gas cylinder 1206. An axial passage 1222 extends through the gas cylinder cap 1220. A pin 1224 is received in the passage 1222 and has a pointed end that punctures the cylinder and a flat head that provides a contact surface for a spike 1226 to contact the head. A cover 1228 receives an end of the gas cylinder cap 1220 and includes an opening 1230 having an O-ring seal 1232 disposed therein. A stem 1234 of the spike 1226 can fit through the opening 1230 and the O-ring seal 1232. Another O-ring seal 1236 fits around the gas cylinder cap 1220 and extends radially outwardly from the radial outer surface of the cover 1228 and the gas cylinder cap 1220. A filter 1238 is positioned downstream from the spike 1226 inside a passage 1242 formed in the pressure regulator 1204. The remainder of the pressure regulator is similar to the pressure regulators described above.

With reference to FIG. 31, when the gas cylinder 1206 is brought towards the pressure regulator 1204, or vice versa, the stem 1234 of the spike 1226 fits into the opening 1230 of the cover 1228 to displace the pin 1224 to puncture the cylinder 1206. The seals 1232 and 1236 prevent leakage. These seals are disposed when the container is removed. Pressurized gas passes from the gas cylinder 1206 through the opening 1222 around the pin 1224. Gas passes through an axial opening 1250 in the spike 1226 and into the pressure regulator 1204.

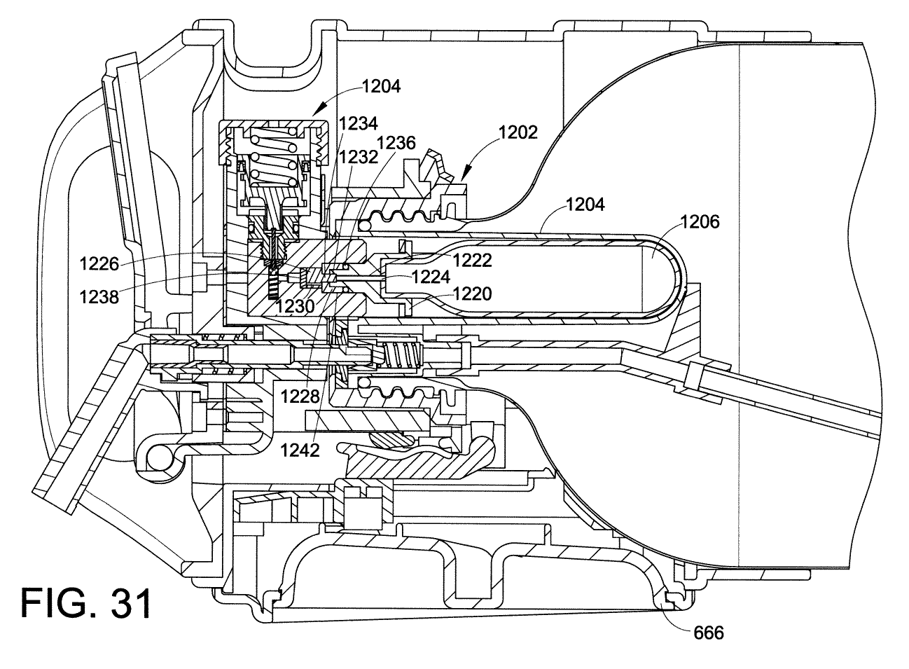

With reference to FIG. 32, a gas cylinder 1306 having a threadless cartridge tip is shown. An O-ring gasket 1308 is disposed between the threadless cartridge tip of the gas cylinder 1306 and a gas cylinder cap 1320. The remainder of the components shown in the embodiment shown in FIG. 32 are the same as the components shown in FIGS. 30 and 31, except what is described below, and therefore for the sake of brevity, further description has not been provided.

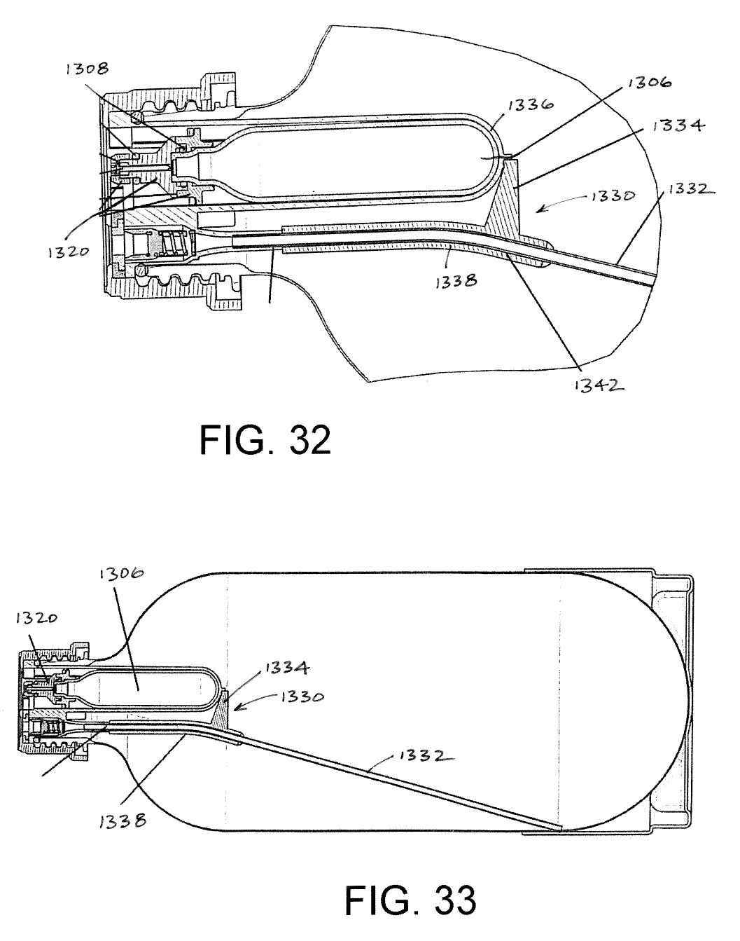

FIG. 32 also discloses a dip tube diverter 1330 that receives a dip tube 1332 similar to the dip tubes described above. The dip tube diverter includes a fin 1334 that contacts and extends from the gas cartridge receptacle 1336. The dip tube diverter 1334 also includes a tubular portion 1338 that includes a passage 1342 that receives the dip tube 1332. As more clearly seen in FIG. 33, the dip tube diverter 1330 imposes a desired bend upon the dip tube 1332. The design shown in FIGS. 32 and 33 also results in one less sealed interface as compared to the design shown in FIGS. 30 and 31. This design also provides a gentle, smooth directional change by virtue of a gradual bend formed in the passage 1342 of the tubular portion 1338 of the dip tube diverter 1330. The remainder of the components for the container and cap assembly shown in FIGS. 32 and 33 are the same or very similar to those described above; therefore, for the sake of brevity further description has not been provided.

Beverage dispensing assemblies and systems have been described with reference to particular embodiments. Many modifications and alterations will occur to those after reading the detailed description. The invention is not limited to only those embodiments that are disclosed above. Instead, the invention is broadly defined by the appended claims and the equivalents thereof.

1. A beverage dispensing system comprising a container holding a beverage charged with a gas and a dispenser that cooperates with the container, the dispenser configured to receive the container, to unseal the container in response to urging together the container and a component of the dispenser, to propel a beverage stored in the container by introducing a pressurized gas into the container to displace the beverage stored in the container and to substantially maintain the charge of gas in the beverage by introducing pressurized gas into the beverage in the container.

2. The system of claim 1, further including a dip tube disposed in the container and a dip tube diverter contacting the dip tube and imposing a bend in the dip tube.

3. The system of claim 1, further comprising a gas cartridge disposed in the container for introducing a pressurized gas into the container, the gas cartridge having a threadless tip.
